(19) United States
(12) Patent Application Publication
(10) Pub. No.: US 2026/0018160 A1
(43) Pub. Date: Jan. 15, 2026

(54) APPROACHES TO TRAINING AND IMPLEMENTING A UNIVERSAL VARIABLE MODEL FOR DYNAMIC VOICE SYNTHESIS AND SYSTEMS FOR ACCOMPLISHING THE SAME

(71) Applicant: Descript, Inc., San Francisco, CA (US)

(72) Inventors: Kundan Kumar, Montréal (CA); Rithesh Kumar, Toronto (CA); Ishaan Kumar, Toronto (CA); Alejandro Luebs, Honolulu, HI (US)

(21) Appl. No.: 19/266,486

(22) Filed: Jul. 11, 2025

Related U.S. Application Data
(60) Provisional application No. 63/670,080, filed on Jul. 11, 2024.

(51) Int. Cl. G10L 13/02; G10L 13/10; G10L 25/30

(52) U.S. Cl. CPC G10L 13/02; G10L 13/10; G10L 25/30; G10L 2013/105

(57) ABSTRACT

Introduced here are approaches to training and then employing computer-implemented models designed to generate synthesized speech using a Universal Variable Model (UVM). The UVM is pre-trained using reference audio samples and associated text prompts to comprehend and replicate various aspects of human speech, including intonation, rhythm, and pronunciation. In the training process, the UVM learns general patterns and relationships between the acoustic properties of speech and the linguistic features of text from a dataset covering different linguistic contexts, accents, and speakers. This enables the UVM to generate natural-sounding speech without the need for personalized training on the user's voice. Users of the media production platform can submit text inputs along with a reference audio sample, and the UVM will produce corresponding audio output in the same voice as the reference sample.

### CROSS-REFERENCE TO RELATED APPLICATIONS

This application claims priority to U.S. Provisional Application No. 63/670,080, titled “Approaches to Training and Implementing a Universal Variable Model for Dynamic Voice Synthesis and Systems for Accomplishing the Same” and filed on Jul. 11, 2024, which is incorporated by reference herein in its entirety.

### TECHNICAL FIELD

Various embodiments concern computer programs and associated computer-implemented techniques for generating synthetic speech.

### BACKGROUND

Artificial intelligence (“AI”) models—also called “machine learning models,” “machine learnt models,” or simply “models”-often operate based on relationships learned from extensive and enormous datasets called “training datasets.” The training datasets include a multiplicity of inputs and labels that indicate how each should be handled. From a training dataset, an algorithm can learn relationships between inputs and labels and represent these learned relationships as a model. Then, when the model receives a new input, the model produces an output based on the relationships learned from the training dataset that the model was trained on.

AI models have been developed and trained to perform various tasks, leading to improvements in performance and fundamentally altering how those tasks are approached and executed. Through iterative training processes, models can extract insights, make predictions, and uncover trends that may not be apparent to human observers. However, not every task is well suited for traditional model development and training methodologies.

One such area where traditional development approaches to AI models have faced challenges is speech synthesis. The term “speech synthesis” is commonly used to refer to the process by which synthetic speech signals are generated from text or other inputs. Generally, this process is performed by a “speech synthesizer” that is implemented in software and/or hardware. The speech synthesized may be implemented as part of a text-to-speech (“TTS”) system that converts natural language text or other linguistic representations, such as phonetic transcriptions, into speech. At a high level, the TTS system converts raw text containing symbols, such as numbers and abbreviations, into the equivalent of written-out words, assigns phonetic transcriptions to each word, and divides and marks the text into prosodic units, such as phrases, clauses, and sentences. The TTS system then converts the symbolic linguistic representation into sound.

Several attempts have been made to replace—or supplement—the speech synthesizers of TTS systems with models that are trained for speech synthesis. The results have been poor, however. One of the significant challenges in speech synthesis arises from the need for robust training datasets to perform speech synthesis effectively. However, as the dataset becomes more extensive and varied, the relationship between content and intonation can become increasingly convoluted. The complexity stems from the diverse ways in which humans express themselves through speech, including nuances in intonation, stress, rhythm, and pacing. Even with a well-curated training dataset, models can struggle to capture the appropriate expressiveness for natural-sounding speech synthesis. This challenge is exacerbated by the limitations of traditional training methodologies, which often focus on improving objective metrics such as accuracy or loss functions without fully accounting for human speech's subjective and dynamic nature. As a result, speech synthesis models trained using conventional approaches may produce outputs that sound robotic, monotone, or otherwise lacking in naturalness. The outputs often fail to mimic the rich diversity of human speech patterns, including variations in pitch, emphasis, and emotional expression. Consequently, synthesized speech may sound artificial or disjointed, negatively impacting the overall user experience and limiting the applicability of speech synthesis technology in various domains.

### BRIEF DESCRIPTION OF THE DRAWINGS

FIG. 1 illustrates a network environment that includes a media production platform.

FIG. 2 illustrates an example of a computing device able to implement a media production platform through which individuals may be able to record, produce, deliver, or consume media content.

FIG. 3 is a block diagram illustrating an example architecture for a universal variable model in a media production platform.

FIG. 4 is a block diagram illustrating an example environment for a dynamic voice synthesis system.

FIG. 5 is a block diagram illustrating an example environment of various models within the universal variable model.

FIG. 6 depicts a flow diagram of a process for generating a universal variable model for voice cloning.

FIG. 7 is a block diagram illustrating an example environment for assigning a speaker to create synthesized speech.

FIG. 8 depicts an example interface for adding a new speaker to the set of available speakers.

FIG. 9 depicts an example interface for selecting a speaker from a set of predefined speakers.

FIG. 10A depicts an example interface for selecting a segment of text in the transcript to regenerate audio.

FIG. 10B depicts an example interface for regenerating audio for a selected segment of text in the transcript.

FIG. 10C depicts an example interface allowing playback of the regenerated audio for the selected segment of text in the transcript.

FIG. 11 depicts a flow diagram of a process for text-to-speech using an assigned speaker and a universal variable model.

FIG. 12 is a block diagram illustrating an example environment for editing a transcript to add and/or delete text.

FIG. 13A depicts an example interface before smoothing audio of an updated transcript.

FIG. 13B depicts an example interface after smoothing audio of an updated transcript.

FIG. 14 depicts a flow diagram of a process for smoothing audio after adding or deleting text to/from an underlying transcript of the audio.

FIG. 15 depicts an example interface for a training statement for generating synthesized speech.

FIG. 16 depicts an example interface for an authorization statement for generating synthesized speech.

FIG. 17 depicts an example interface of an unauthorized speaker.

FIG. 18 depicts a flow diagram of a security process implemented when generating synthesized speech.

FIG. 19 is a high-level block diagram illustrating an example AI system, in accordance with one or more embodiments.

FIG. 20 is a block diagram illustrating an example computer system, in accordance with one or more embodiments.

Features of the technology described herein will become more apparent to those skilled in the art from a study of the Detailed Description in conjunction with the drawings. Various embodiments are depicted in the drawings for the purpose of illustration. However, those skilled in the art will recognize that alternative embodiments may be employed without departing from the principles of the present disclosure. Accordingly, although specific embodiments are shown in the drawings, the technology is amenable to various modifications.

### DETAILED DESCRIPTION

Text-to-speech (“TTS”) technology is useful in multimedia editing, where TTS technology converts written text into spoken language and enables users to review, edit, and annotate audio content. However, conventional TTS systems struggle to produce speech that accurately reflects the nuances of human speech, leading to robotic or unnatural-sounding results. The discrepancy stems from the inherent complexity of mapping written text to spoken language, where subtle variations in intonation, rhythm, and pronunciation play a crucial role in conveying meaning and emotion. Existing TTS approaches face limitations in capturing the dynamic nature of human speech, including variations in pitch, cadence, and emphasis, which can vary widely across different speakers and linguistic contexts.

For example, an individual editing a podcast is interested in replacing a segment of the audio where there was an error using TTS technology to fill in the gap with the new audio. However, when the individual uses conventional TTS systems, the synthesized speech inserted into the audio may be noticeably disjointed and robotic compared to the surrounding natural speech. The resulting output may sound jarring to listeners, detracting from the overall listening experience.

Additionally, conventional TTS systems require large amounts of training data specific to each language or speaker, making the system resource-intensive and time-consuming to develop and maintain. The reliance on extensive training datasets also limits the scalability and generalization capabilities of conventional TTS models, particularly in scenarios where data availability is limited or linguistic diversity is high. As a result, conventional TTS systems may struggle to achieve the level of adaptability desired for real-world applications in areas such as accessibility, communication aids, virtual assistants, and entertainment media, while also maintaining widespread applicability.

For example, in a multimedia editing platform using conventional TTS systems, every user would be required to undergo a personalized training process to adapt the system to the user's unique voice characteristics and speech patterns (e.g., by reading a series of predefined passages or sentences and using the audio as training data to train the model). However, the process of training each user's voice individually is time-consuming and resource-intensive, especially in platforms with large user bases. Additionally, the effectiveness of the system varies depending on factors such as the quality of the training data and the consistency of the user's speech during the training process.

Further, conventional TTS systems require a robust training dataset that typically includes samples from numerous speakers. However, the diversity of speakers causes it to be challenging to discern specific patterns or characteristics that contribute to realistic speech synthesis. With such a wide array of voices in the dataset, the model may struggle to learn distinct features or nuances associated with individual speakers. Moreover, when aiming to replicate the voice of a particular speaker, the replication using conventional TTS systems typically require acquiring large amounts of training data from that specific individual. Thus, conventional models designed for TTS applications are not suitable due to their generalization across multiple speakers, but at the same time are not suitable because training a separate model for each speaker is impractical and inefficient, especially when dealing with a large number of potential speakers.

Introduced here are computer programs and associated computer-implemented techniques for generating synthesized speech using a universal variable model (“UVM”). The UVM may be trained to understand and emulate various aspects of human speech, such as intonation, rhythm, and pronunciation. For the purpose of illustration, the UVM may be described as a neural network. However, those skilled in the art will recognize that another algorithm—and therefore, another type of model-could be used without deviating from the features of the embodiments described below.

Unlike traditional TTS systems that rely on specific training data for each language or speaker, the UVM is pre-trained using reference audio samples and associated text prompts to learn the underlying patterns of speech generation. To train the UVM, a dataset including reference audio samples and associated text prompts covering various linguistic contexts, accents, and speakers is provided. The UVM then learns, from the dataset, general patterns and relationships between the acoustic properties of speech and the linguistic features of the corresponding text. Then, the media production platform can apply a computer-implemented model (e.g., the UVM) generally to all users of the media production platform. When users submit text inputs along with a reference audio sample (e.g., by providing a sample of the user's own voice or assigning a speaker's voice from a set of pre-made speaker samples), the UVM generates corresponding audio output in the same voice as that of the reference audio sample, converting the written text into natural-sounding speech without first training the model on the user's voice. The capability to mimic individual voices despite lacking a personalized TTS model improves the model's utility across various use cases, from text-to-speech applications to audio editing tasks with multiple speakers.

The media production platform can, using the UVM, generate new audio based on existing transcripts and integrate the new audio smoothly with the original audio. For example, in scenarios involving text addition and/or deletion, the model adjusts the audio while preserving the natural-sounding aspect of the original audio. The UVM uses the model's understanding of speech dynamics to upscale existing audio or generate new segments to generate a smooth transition between edits. By assessing the context surrounding the edit points, the UVM produces synthesized speech that matches the tone and style of the surrounding audio, which improves the overall coherence and quality of the audio output.

Additionally, the media production platform can verify the request of the users before generating audio overdubs to mitigate the risk of unauthorized use or manipulation of voice recordings. Further, the media production platform can, through the UVM, prioritize requests depending on various factors (e.g., the number of previous requests, time since the last request) and implement rate-limiting mechanisms to prevent potential misuse of the multimedia editing platform. For example, an individual attempts to manipulate the system by hacking into the document processing pipeline to convert overdub requests into processing state before obtaining proper consent. Upon receiving an overdub request, the backend of the multimedia editing platform first verifies whether the corresponding voice has consented. If the system detects that consent has not been granted, the system refrains from fully processing the overdub request and instead prompts the individual to obtain proper consent before proceeding.

For the purpose of illustration, embodiments may be described in the context of improving the quality of audio including human voices. However, those skilled in the art will recognize that the approaches described herein may be similarly applicable to other audio domains. As an example, the media production platform could implement the approaches described herein to produce studio sound files from lower-quality recordings of musical performances on the street or in the home. Accordingly, the approaches described herein are not limited to improving the sound quality of speech.

Note that while embodiments may be described in the context of computer-executable instructions for the purpose of illustration, aspects of the technology can be implemented via hardware, firmware, software, or any combination thereof. As an example, a media production platform may be embodied as a computer program through which an individual may be permitted to review content (e.g., text, audio, or video) to be incorporated into a media compilation, create media compilations by compiling different forms of content or multiple files of the same form of content, and initiate playback or distribution of media compilations.

### Overview of Media Production Platform

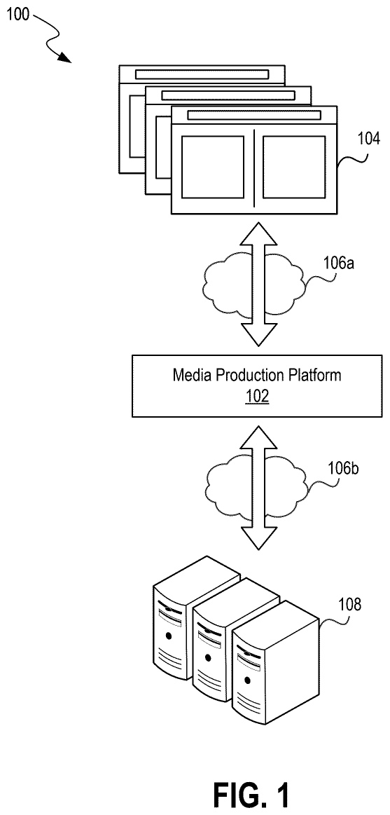

FIG. 1 illustrates a network environment 100 that includes a media production platform 102. Individuals (also referred to as “users” or “developers”) can interact with the media production platform 102 via interfaces 104 as further discussed below. For example, individuals may be able to generate, edit, or view media content through the interfaces 104. Examples of media content include text content such as stories and articles, audio content such as radio segments and podcasts, and video content such as television programs and presentations. Meanwhile, the individuals may be persons interested in recording media (e.g., audio content) or editing media (e.g., to create a podcast or audio tour).

As shown in FIG. 1, the media production platform 102 may reside in a network environment 100. Thus, the computing device on which the media production platform 102 is executing may be connected to one or more networks 106a-b. The network(s) 106a-b can include personal area networks (PANs), local area networks (LANs), wide area networks (WANs), metropolitan area networks (MANs), cellular networks, the Internet, etc. Additionally or alternatively, the computing device can be communicatively coupled to other computing device(s) over a short-range wireless connectivity technology, such as Bluetooth®, Near Field Communication (NFC), Wi-Fi® Direct (also referred to as “Wi-Fi P2P”), and the like. As an example, the media production platform 102 is embodied as a “cloud platform” that is at least partially executed by a network-accessible server system in some embodiments. In such embodiments, individuals may access the media production platform 102 through computer programs executing on their own computing devices. For example, an individual may access the media production platform 102 through a mobile application, desktop application, over-the-top (OTT) application, or web browser. Accordingly, the interfaces 104 may be viewed on personal computers, tablet computers, mobile phones, wearable electronic devices (e.g., watches or fitness accessories), network-connected electronic devices (also called “smart electronic devices”) such as televisions or home assistant devices), gaming consoles, virtual or augmented reality systems (e.g., head-mounted displays), and the like.

In some embodiments, at least some components of the media production platform 102 are hosted locally. That is, part of the media production platform 102 may reside on the computing device that is used to access the interfaces 104. For example, the media production platform 102 may be embodied as a desktop application executing on a personal computer. Note, however, that the desktop application may be communicatively connected to a network-accessible server system 108 on which other components of the media production platform 102 are hosted.

In other embodiments, the media production platform 102 is executed entirely by a cloud computing service operated by, for example, Amazon Web Services®, Google Cloud Platform™, or Microsoft Azure®. In such embodiments, the media production platform 102 may reside on a network-accessible server system 108 comprised of one or more computer servers. These computer servers can include media and other assets, such as digital signal processing algorithms (e.g., for processing, coding, or filtering audio signals), heuristics (e.g., rules for determining whether to improve the quality of incoming audio signals, rules for determining the degree to which the quality of incoming audio signals should be improved), and the like. Those skilled in the art will recognize that this information could also be distributed amongst a network-accessible server system and one or more computing devices. For example, media content may be stored on a personal computer that is used by an individual to access the interfaces 104 (or another computing device, such as a storage medium, that is accessible to the personal computer) while digital signal processing algorithms may be stored on a computer server that is accessible to the personal computer via a network.

As further discussed below, the media production platform 102 can facilitate the production of studio-quality recordings (called “studio sound files” or “studio audio files”) through the application of a trained model on waveforms corresponding to lesser-quality recordings. Generally, these waveforms are obtained by the media production platform 102 in the form of audio files. Thus, an individual may be able to select an audio file and then specify that the quality of the audio file should be improved. Alternatively, upon receiving input indicative of a selection of an audio file, the media production platform 102 may automatically improve the media production platform's 102 quality in response to determining that the quality (e.g., as measured in clarity, signal-to-noise ratio, etc.) either falls beneath a threshold or is meaningfully less than other audio files to be included in the same media compilation. In some embodiments, the media production platform 102 is programmed to automatically improve the quality of all audio files that are selected, identified, or otherwise made available for inclusion in media compilations by the media production platform 102.

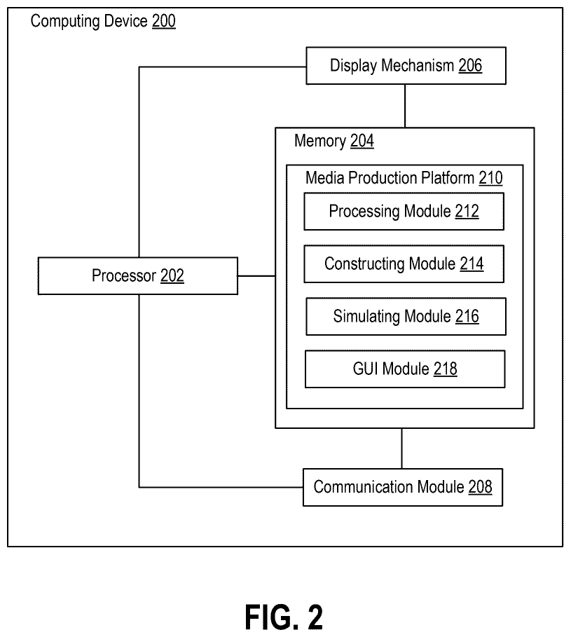

FIG. 2 illustrates an example of a computing device 200 able to implement a media production platform 210 through which individuals may be able to record, produce, deliver, or consume media content. For example, in some embodiments, the media production platform 210 is designed to generate interfaces through which developers can generate or produce media content, while in other embodiments the media production platform 210 is designed to generate interfaces through which consumers can consume media content. In some embodiments, the media production platform 210 is embodied as a computer program that is executed by the computing device 200. In other embodiments, the media production platform 210 is embodied as a computer program that is executed by another computing device (e.g., a computer server) to which the computing device 200 is communicatively connected. In such embodiments, the computing device 200 may transmit relevant information, such as media content created, recorded, or otherwise acquired by the individual, to the other computing device for processing. Those skilled in the art will recognize that aspects of the computer program could also be distributed amongst multiple computing devices.

The computing device 200 can include a processor 202, memory 204, display mechanism 206, and communication module 208. The communication module 208 may be, for example, wireless communication circuitry designed to establish communication channels with other computing devices. Examples of wireless communication circuitry include integrated circuits (also referred to as “chips”) configured for Bluetooth, Wi-Fi, NFC, and the like. The processor 202 can have generic characteristics similar to general-purpose processors, or the processor 202 may be an application-specific integrated circuit (ASIC) that provides control functions to the computing device 200. As shown in FIG. 2, the processor 202 can be coupled to all components of the computing device 200, either directly or indirectly, for communication purposes.

The memory 204 may be comprised of any suitable type of storage medium, such as static random-access memory (SRAM), dynamic random-access memory (DRAM), electrically erasable programmable read-only memory (EEPROM), flash memory, or registers. In addition to storing instructions that can be executed by the processor 202, the memory 204 can also store data generated by the processor 202 (e.g., when executing the modules of the media production platform 210). Note that the memory 204 is merely an abstract representation of a storage environment. The memory 204 could be comprised of actual memory chips or modules.

The communication module 208 can manage communications between the components of the computing device 200. The communication module 208 can also manage communications with other computing devices. Examples of computing devices include mobile phones, tablet computers, personal computers, and network-accessible server systems comprised of one or more computer servers. For instance, in embodiments where the computing device 200 is associated with a developer, the communication module 208 may be communicatively connected to a network-accessible server system on which processing operations, heuristics, and algorithms for producing media content are stored. In some embodiments, the communication module 208 facilitates communication with one or more third-party services that are responsible for providing specified services (e.g., transcription or speech generation). The communication module 208 may facilitate communication with these third-party services through the use of application programming interfaces (APIs), bulk data interfaces, etc.

For convenience, the media production platform 210 may be referred to as a computer program that resides within the memory 204. However, the media production platform 210 could be comprised of software, firmware, or hardware implemented in, or accessible to, the computing device 200. In accordance with embodiments described herein, the media production platform 210 may include a processing module 212, constructing module 214, simulating module 216, and graphical user interface (GUI) module 218. These modules may be an integral part of the media production platform 210. Alternatively, these modules may be logically separate from the media production platform 210 but operate “alongside” it. Together, these modules enable the media production platform 210 to generate and then support the interfaces through which an individual can create, record, edit, or consume media content.

The processing module 212 may be responsible for ensuring that data obtained (e.g., retrieved or generated) by the media production platform 210 is in a format suitable for the other modules. Thus, the processing module 212 may apply operations to alter media content obtained by the media production platform 210. For example, the processing module 212 may apply denoising, filtering, and/or compressing operations to media content obtained by the media production platform 210. As noted above, media content could be acquired from one or more sources. The processing module 212 may be responsible for ensuring that these data are in a compatible format, temporally aligned, etc.

As further discussed below, the constructing module 214 may design, develop, or train a model that takes a first waveform as input, converts the first waveform into a representation, and then converts the representation into a second waveform. The model may be representative of a concatenation of multiple models, and therefore may be referred to as a “superset model.” More specifically, this model may include (i) a first set of algorithms—representative of a first model—that is able to produce the representation from the first waveform and (ii) a second set of algorithms-representative of a second model—that is able to produce the second waveform from the representation. As discussed above, the first model may be representative of a “reverse” vocoder while the second model may be representative of a “forward” vocoder.

At a high level, the superset model is representative of a machine learning framework that includes the first and second models. The constructing module 214 may not only be responsible for developing the superset model, but also the first and second models. For example, the constructing module 214 may be responsible for identifying a “forward” vocoder that can be used as the second model and then developing an appropriate “backward” vocoder based on the “forward” vocoder. The constructing module 214 may identify the “forward” vocoder from amongst a series of “forward” vocoders based on the desired capabilities of the superset model. For example, the “forward” vocoder could be identified based on a desired quality (e.g., in terms of signal-to-noise ratio, gain, or some other characteristic) of the “clean” audio to be output by the superset model.

In some embodiments, the constructing module 214 is responsible for training the superset model. Assume, for example, that the superset model is representative of a GAN. In such a scenario, the constructing module 214 can train the superset model in an adversarial manner, namely, with a generator and an encoder. To ensure good performance, the constructing module may utilize two losses, namely, an adversarial loss and a reconstruction loss, during the training process. Training is discussed in further detail below.

In other embodiments, a separate module may be responsible for training the superset model designed, developed, or otherwise obtained by the constructing module 214. This other module may be referred to as a “training module.” The training module could be part of the media production platform 210, or the training module may be accessible to the media production platform 210. For example, the training module may be executed by another computing device to which the computing device 200 is communicatively connected.

Accordingly, the constructing module 214 may be responsible for designing, developing, or training (e.g., in conjunction with the training module) the superset model that is applied by the simulating module 216. Assume, for example, that the media production platform 210 acquires input indicative of a request to improve the quality of a first audio file. Upon acquiring the input, the simulating module 216 can acquire the first audio file. In some embodiments, the first audio file is included in the input. For example, a user may upload the first audio file to the media production platform 210 through an interface that is generated by the GUI module 218, and the act of uploading the first audio file may be indicative of the input. In other embodiments, the first audio file is referenced in the input. For example, the input may reference the name of the first audio file, a speaker whose voice is included in the first audio file, or a media compilation that the first audio file is to be used to create. In embodiments where the first audio file is referenced in the input, the simulating module 216 may acquire the first audio file. For example, the simulating module 216 may retrieve the first audio file from the memory 204, or the simulating module 216 may retrieve the first audio file from another memory that is accessible (e.g., by the communication module 208) via a network.

The simulating module 216 can then apply the superset model to the first audio file, so as to produce a second audio file as output. As further discussed below, applying the superset model to the first audio file may result in manipulation of the underlying audio signal. The underlying audio signal can be manipulated to sound as if recording occurred with sophisticated equipment in a high-quality recording studio. As such, the second audio file may be referred to as a “studio sound file” or “studio audio file.” Studio sound values obtained by the simulating module 216 through application of the superset model can be stored in the memory 204 or another memory external to the computing device 200. In some embodiments, studio sound files are stored in data structures that correspond to media compilations. For example, each studio sound file may be stored in a data structure maintained for a media compilation in which that studio sound file is to be used.

The GUI module 218 may be responsible for generating the interfaces through which users can interact with the media production platform 210. The interfaces may include visual indicia representative of the audio files (e.g., studio sound files) that can be used to create a media compilation, or these interfaces may include a transcript that can be edited to globally effect changes to a corresponding media compilation. For example, if a user deletes a segment of a transcript that is visible on an interface, the media production platform 210 may automatically delete a corresponding segment of audio content from an audio file (e.g., a studio sound file) associated with the transcript.

### Overview of Dynamic Voice Synthesis System

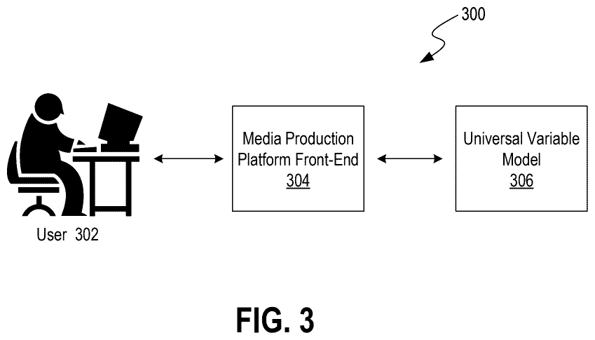

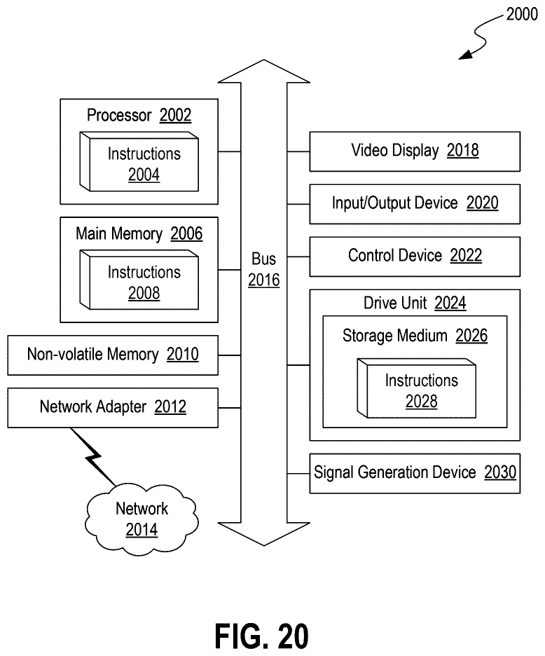

FIG. 3 is a block diagram illustrating an example architecture 300 for a universal variable model in a media production platform. The example architecture 300 includes a user 302, a media production platform front-end 304, and a universal variable model (UVM) 306. Media production platform containing media production platform front-end 304 is the same as or similar to media production platform 102 and media production platform 210 illustrated and described in more detail with reference to FIGS. 1 and 2. The example architecture 300 can be implemented using components of the example computer system 2000 illustrated and described in more detail with reference to FIG. 20. Likewise, embodiments of the example architecture 300 can include different and/or additional components that can be connected in different ways.

The user 302 is the individual (e.g., individuals discussed with reference to FIG. 1) or entity engaging with the media production platform front-end 304. For example, a user 302 can be a content creator accessing the media production platform through a web browser on a personal computer or laptop. The media production platform front-end 304 is an interface that provides users (e.g., user 302) with a visually intuitive platform to access and manipulate the integrated functionalities in the media production platform. The user 302 uses input devices such as a keyboard, mouse, or touchscreen to navigate the media production platform front-end 304 to provide commands, input text, select options, and trigger actions within the media production platform front-end 304.

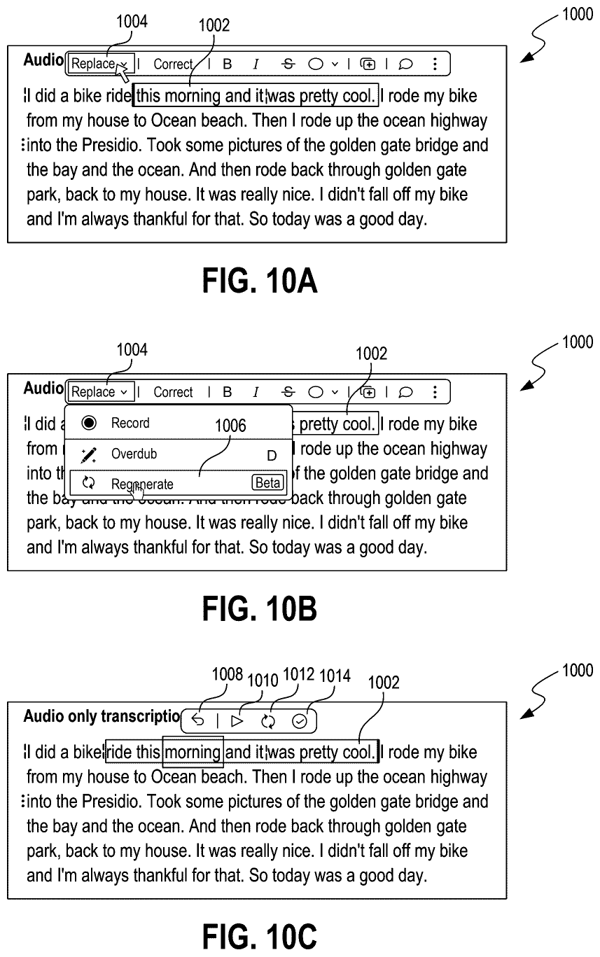

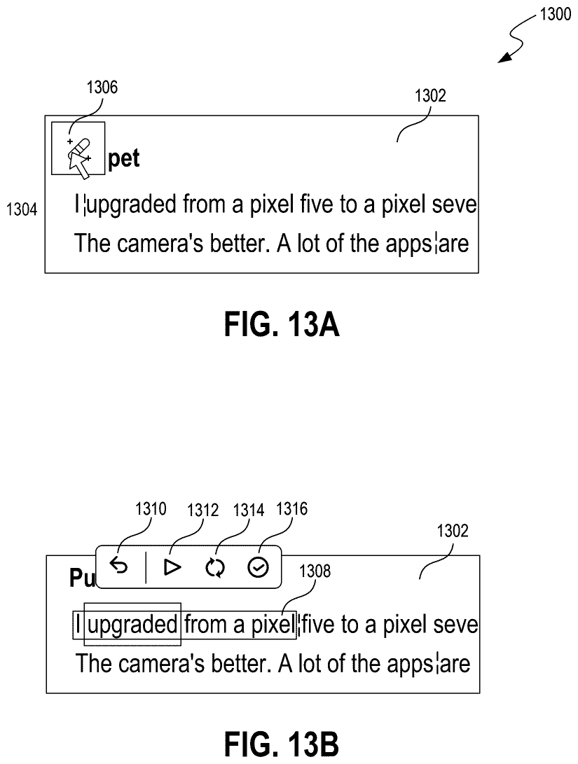

Upon receiving input from the user 302, the media production platform front-end 304 processes the user's commands and forwards relevant information to the UVM 306 for further processing. The media production platform front-end 304 can interpret the user's inputs, such as mouse clicks, keyboard strokes, or touchscreen gestures, to understand the user's intentions and translate these inputs into actionable commands or requests. Example methods of interpreting user inputs are discussed further with reference to FIGS. 10A-C and FIGS. 13A-B. The media production platform front-end 304 can communicate with the UVM 306 through an Application Programming Interface (API) or established communication protocols (e.g., HTTP, WebSocket).

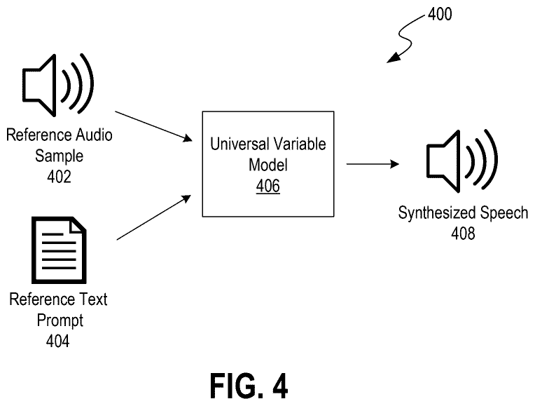

The UVM 306 provides text-to-speech (TTS) capabilities within the media production platform. The UVM 306 can interpret user inputs, process textual data, and generate synthesized speech outputs. The UVM 306 converts textual inputs from the user 302 into natural-sounding audio outputs. The UVM 306 includes various modules responsible specific aspects of the TTS process. The modules include, for example, text preprocessing layers, feature extraction components, neural network models for speech synthesis, and post-processing modules for upscaling the quality of synthesized speech outputs. Methods and algorithms used by the UVM 306 to produce synthesized speech outputs are illustrated and described in more detail with reference to FIGS. 4-7.

FIG. 4 is a block diagram illustrating an example environment 400 for a dynamic voice synthesis system. The example environment 400 includes reference audio sample 402, reference text prompt 404, UVM 406, and synthesized speech outputs 408. UVM 406 is the same as or similar to UVM 306 illustrated and described in more detail with reference to FIG. 3. The example environment 400 can be implemented using components of the example computer system 2000 illustrated and described in more detail with reference to FIG. 20. Likewise, embodiments of the example environment 400 can include different and/or additional components that can be connected in different ways.

The reference audio sample 402 and the reference text prompt 404 serve as inputs into the UVM 406. The reference audio sample 402, which contains audio data representing a specific speaker's voice, is captured and digitized using hardware devices such as microphones or audio interfaces. The reference audio sample 402 encapsulates the distinctive acoustic characteristics and vocal nuances of a specific speaker, providing reference points for the UVM 406. The reference audio sample 402 can be stored in a digital format, such as WAV or MP3. The reference text prompt 404 encapsulates the linguistic features and textual content intended for conversion into speech. The reference text prompt 404, which includes textual data, can be entered manually by a user through a keyboard or touchscreen interface, or the reference text prompt 404 may be imported from external sources such as text files or databases.

The UVM 406 analyzes the reference audio sample 402 and the reference text prompt 404 to generate synthesized speech. Through an iterative process of feature extraction, pattern recognition, and/or neural network inference, the UVM 406 generates synthesized speech outputs 408 that closely emulate the speech patterns, intonations, and vocal characteristics inherent in the reference audio sample 402 while adhering to the linguistic features present in the reference text prompt 404. Methods and algorithms used by the UVM 406 to produce synthesized speech outputs are illustrated and described in more detail with reference to FIGS. 4-7. The synthesized speech outputs 408 can be integrated into various applications (e.g., multimedia content creation, interactive voice-based interfaces). For example, the synthesized speech outputs 408 can be used to generate voiceovers, narrations, or character dialogues for videos, animations, or interactive media. By incorporating natural-sounding synthesized speech outputs 408, content creators can add dynamic elements to their creations.

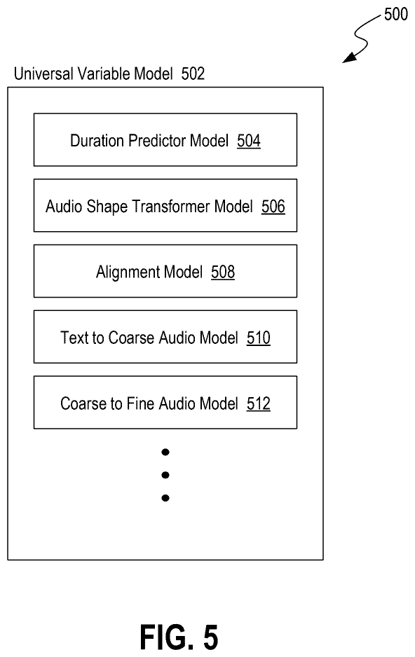

FIG. 5 is a block diagram illustrating an example environment 500 of various models within the universal variable model. The example environment 500 includes reference UVM 502, duration predictor model 504, audio shape transformer model 506, alignment model 508, text-to-coarse audio model 510, and coarse-to-fine audio model 512. UVM 502 is the same as or similar to UVM 306 and UVM 406 illustrated and described in more detail with reference to FIGS. 3 and 4 respectively. The example environment 500 can be implemented using components of the example computer system 2000 illustrated and described in more detail with reference to FIG. 20. Likewise, embodiments of the example environment 500 can include different and/or additional components that can be connected in different ways.

The UVM 502 can be a meta-model that includes various specialized models designed to address distinct aspects of speech synthesis. The models include a duration predictor model 504, audio shape transformer model 506, alignment model 508, text-to-coarse audio model 510, and coarse-to-fine audio model 512. Each of the models 504, 506, 508, 510, 512 contribute piecemeal functionalities and capabilities that together generate synthesized speech outputs.

The duration predictor model 504 predicts the temporal duration of individual phonemes, words, or phrases within the reference audio sample (e.g., reference audio sample 402). By estimating the duration of speech segments, the duration predictor model 504 determines the proper pacing and rhythm of the reference audio sample, improving the naturalness and intelligibility of the resulting synthesized speech output. The phonemes, words, and/or phrases are segmented into individual phonemes or linguistic units to extract relevant features. The phonemes or linguistic units are then used to generate a mel spectrogram, which is a visual representation of the spectrum of frequencies in a speech signal over time. A mel spectrogram captures spectral characteristics and acoustic properties relevant to the speech generation process. The duration predictor model is trained on a dataset containing pairs of input text and their corresponding phonetic segment durations. During training, the model learns to associate specific phonetic contexts with their corresponding durations by observing patterns and relationships in the training data. Further methods of training a model are discussed with reference to FIG. 20. The mel spectrogram, along with phonetic information extracted from the text, are fed into a duration predictor model. The duration predictor model 504 generates predicted durations representing the anticipated length of time that each phonetic segment, such as a phoneme or word, should be pronounced during the speech synthesis process.

The audio shape transformer model 506 is a neural audio codec that transforms the acoustic shape of the waveform of the reference audio sample. The audio shape transformer model 506 operates by compressing audio signals into acoustic tokens at a specified bit rate. The acoustic tokens represent compact representations of the audio waveform, facilitating efficient storage and transmission while preserving acoustic information. In some embodiments, the audio shape transformer model 506 uses deep learning architectures, such as convolutional neural networks (CNNs) or recurrent neural networks (RNNs), to capture salient features from the input audio waveform. For example, CNNs capture spectral features, such as frequency patterns and harmonics by convolving input audio waveforms with learnable filters and detecting patterns at different scales. Additionally, RNNs model sequential data and capture temporal dependencies over time. For example, RNNs model temporal dynamics, such as the evolution of sound over time or the rhythm and cadence of speech. By recurrently processing sequential input data through recurrent units, such as Long Short-Term Memory (LSTM) or Gated Recurrent Unit (GRU) cells, RNNs capture long-range dependencies and contextual information present in audio signals.

In some embodiments, the compression process incorporates techniques such as quantization and vector quantization to further reduce the dimensionality of the encoded representations. Quantization involves mapping continuous values to a discrete set of levels, reducing the precision of the encoded data. Vector quantization, on the other hand, partitions the feature space into a predefined set of clusters and assigns each input vector to the nearest cluster centroid, resulting in a more compact representation.

The audio shape transformer model 506 can use pre-measured audio signals of length B×L, where B represents the batch size and L denotes the length of each audio sequence in terms of samples. The bitrate or compression ratio used during the encoding process directs the trade-off between fidelity and compression efficiency, where higher bitrates preserve more details at the expense of increased data storage requirements. For example, audio shape transformer model 506 compresses the 44.1 KHz audio into acoustic tokens at an 8 kbps bitrate by transforming the audio of length B×L into acoustic tokens of shape B×(L//412)×9, where 412 is the striding factor of the encoder, and 9 is the number of 10-bit quantizers used for quantization.

In some embodiments, the audio shape transformer model 506 refines spectral characteristics and temporal dynamics of the audio waveform using Residual Vector Quantization (RVQ) for quantization. RVQ begins by initializing a codebook, which is a collection of codewords or code vectors. The code vectors represent representative points in the data space and serve as reference points for quantization. When a new input vector is encountered, RVQ quantizes the vector by finding the closest code vector in the codebook (e.g., by using a nearest neighbor search algorithm such as k-nearest neighbors or tree-based search methods like KD-trees). After quantization, RVQ computes the residual, which is the difference between the input vector and the quantized code vector. This residual captures the portion of the input signal that cannot be accurately represented by the code vector alone. RVQ iteratively refines the quantization by quantizing the residual signal obtained in the previous step. The process continues for multiple iterations, with each iteration improving the accuracy of the quantization. Periodically, the codebook is updated to adapt to changes in the input data distribution. This can involve adding new code vectors, removing redundant ones, or adjusting the positions of existing code vectors based on the input data distribution. Once quantization is complete, the quantized data, along with any additional information needed for reconstruction, is transmitted or stored. During reconstruction, the quantized data is decoded by using the codebook to reconstruct the original input data as accurately as possible.

The alignment model 508 aligns the acoustic properties of the reference audio sample with the linguistic features of the reference text input and generates an alignment matrix based on the input text represented as International Phonetic Alphabet (IPA) symbols and the audio represented as acoustic tokens (e.g., the acoustic tokens produced by the audio shape transformer model 506). The model can receive reference text input in an IPA representation. In some embodiments, the model preprocesses the reference text input by converting the text into IPA representations, which involves mapping the linguistic features of the reference text input to their corresponding IPA symbols. The text input is structured in a tensor format of shape B×T, where B represents the batch size and T represents the maximum sequence length of IPA symbols in the batch. The audio input (e.g., from the reference audio sample) is in the form of audio tokens and can be structured in a tensor format of shape B×L×9, where B represents the batch size, L represents the sequence length of tokens, and 9 represents the number of dimensions for each token.

The alignment model 508 processes the text input and the audio input to produce an alignment matrix. The matrix has a shape of B×L, where each element corresponds to a timestep in the audio sequence and points to the index of the phoneme that is voiced at that timestep. For each timestep in the audio sequence, the alignment model 508 determines a corresponding phoneme that is voiced. Each phoneme in the audio sequence is associated with an index. The alignment model 508 can iterate over the audio sequence, and for each timestep, determine the index of the phoneme that is voiced at that timestep. The alignment model 508 assigns the index to the corresponding element in the alignment matrix. If processing multiple audio sequences in batches (e.g., with batch size B), the phenome extraction and indice assignment steps are iterated for each sequence in the batch. Once the alignment matrix is populated for all audio sequences in the batch, the matrix can be used for further processing, the alignment matrix is complete. The alignment matrix ensures coherence and synchronization between the acoustic properties of the audio and the linguistic features of the input text, preserving the semantic and syntactic integrity of the speech synthesis process.

The text-to-coarse audio model 510 translates textual inputs into coarse acoustic representations (e.g., acoustic tokens). Through neural network architectures and signal processing techniques, the text-to-coarse audio model 510 generates preliminary acoustic tokens corresponding to the linguistic features encoded in the input text. The input for the text to coarse audio model 510 can include the outputs of the duration predictor model 504, the audio shape transformer model 506, and/or the alignment model 508. For example, inputs can include predicted durations, acoustic tokens, and an alignment matrix between the reference audio sample and the reference text input. The acoustic tokens represent coarse representations of the audio waveform, while the predicted durations provide information about the temporal characteristics of each phoneme. The alignment matrix aligns the acoustic properties of the audio with the corresponding linguistic elements. The text-to-coarse audio model 510 can use the alignment matrix to help align the acoustic properties of the audio with the corresponding linguistic elements, and use the predicted durations to aid in modeling the temporal dynamics of the speech. The text-to-coarse audio model 510 generates refined acoustic representations based on the input textual information, predicted durations, and alignment matrix.

In some embodiments, the text-to-coarse audio model 510 is trained using a fill-in-the-middle augmentation. The training data set introduces gaps or masked regions in the input audio data, simulating missing segments that need to be imputed. During training, random segments of the input data can be masked, and the text-to-coarse audio model 510 is provided with both the masked input and the original unmasked input. A loss function can be used to train the model to accurately predict the missing segments. For example, mean squared error (MSE) loss calculates the average squared difference between the predicted values and the ground truth across all data points, and penalizes large errors more heavily. In use cases where accuracy is more crucial, MSE can be used since MSE penalizes large errors more heavily. When the text-to-coarse audio model 510 is deployed to generate coarse acoustic tokens, the text-to-coarse audio model 510 is provided with input audio samples containing masked segments (e.g., text input without a corresponding audio sample), allowing the text-to-coarse audio model 510 to predict the missing portions.

Subsequently, the coarse-to-fine audio model 512 operates on the coarse acoustic representations generated by the text-to-coarse audio model 510, refining and enriching the coarse acoustic representations to produce synthesized speech outputs. The coarse-to-fine audio model 512 can use machine learning algorithms and signal processing methodologies to enhance the quality and naturalness of the synthesized speech waveform. By adjusting spectral characteristics, temporal dynamics, and prosodic features, the coarse-to-fine audio model 512 transforms the coarse acoustic tokens into more finely detailed speech waveforms that mimic natural human speech.

The coarse-to-fine audio model 512 can receive a sequence of tokens (e.g., the coarse acoustic tokens created by the text-to-coarse audio model 510) and sum the embeddings corresponding to the same frame, including the embedding of the conditioning token. The coarse-to-fine audio model 512 can follow a masking scheme for training the model. The masking process follows a coarse-to-fine ordering, which means that tokens at coarser levels of the RVQ hierarchy (e.g., those with larger residual errors) are masked before tokens at finer levels. The ordering respects the conditional dependencies between levels of the RVQ hierarchy, ensuring that the coarse-to-fine audio model 512 learns to predict tokens at each level based on the information provided by the previous levels. Additionally, the masking scheme uses the conditional independence of tokens from finer levels given tokens from coarser levels, allowing for efficient training by masking out tokens at finer levels that are not directly influenced by tokens at coarser levels.

To generate the acoustic tokens, the coarse-to-fine audio model 512 can use an iterative parallel decoding scheme. The decoding process masks out all acoustic tokens except those corresponding to the prompt, which provides the initial context for generating the acoustic tokens. The decoding proceeds in a coarse-to-fine order, sampling tokens at each level of the RVQ hierarchy. Within each RVQ level, a confidence-based sampling scheme is used to select candidate tokens for the masked positions. The scheme involves performing multiple forward passes through the model and sampling candidates based on their confidence scores, which indicate the likelihood that a token is the correct prediction for a given position. The most confident candidates are retained for each masked position, ensuring that the generated acoustic tokens are of high quality and consistent with the conditioning tokens.

In some embodiments, the UVM can incorporate adaptive filtering techniques to dynamically adjust the spectral and temporal properties of the synthesized speech in response to input conditions or user preferences. Adaptive filtering algorithms, such as recursive least squares (RLS) or least mean squares (LMS), continuously update filter coefficients based on incoming speech signals, ensuring optimal adaptation to changing acoustic environments or speaker characteristics.

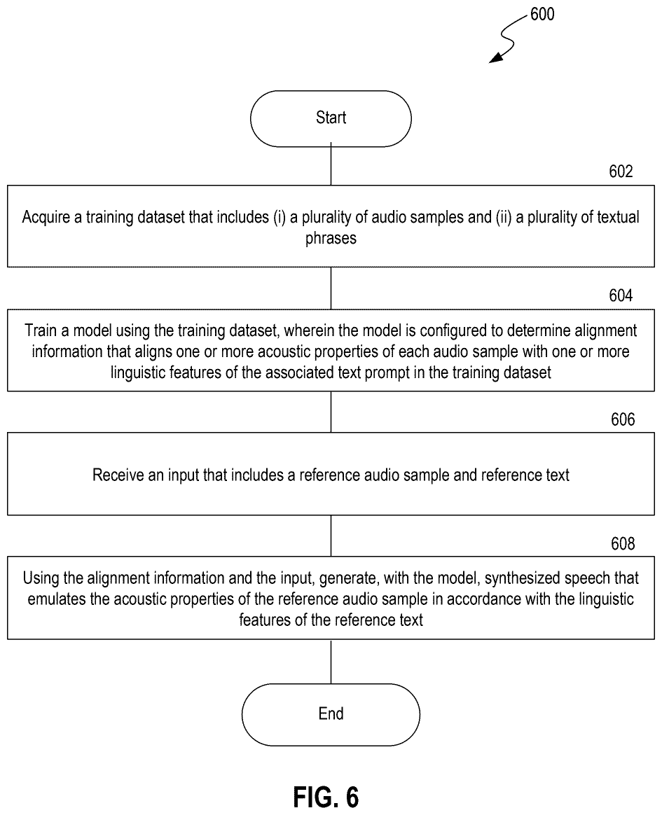

FIG. 6 depicts a flow diagram of a process 600 for generating a universal variable model for voice cloning. In one example, the process 600 is performed by a computer system such as a media production platform (e.g., the media production platform 102 in FIG. 1, the media production platform 210 in FIG. 2) to generate the synthesized speech. In some embodiments, the process 600 is performed by a computer system, e.g., computer system 2000 illustrated and described in more detail with reference to FIG. 20. Likewise, embodiments can include different and/or additional steps or can perform the steps in different orders.

In step 602, the system acquires a training dataset that includes (i) a plurality of audio samples and (ii) a plurality of textual phrases. Example reference audio samples 402 are illustrated and described in more detail with reference to FIG. 4. Example reference text prompts 404 are illustrated and described in more detail with reference to FIG. 4.

In step 604, the system trains a universal model (e.g., UVM 502) using the training dataset. In some embodiments, the system provides the training data, as input, to a model that determines alignment information by, for each audio sample in the set of audio samples, aligning one or more acoustic properties of that audio sample with one or more linguistic features of the corresponding one of the associated text prompts. The universal model can determine alignment information that aligns acoustic properties of each audio sample with linguistic features of the associated text prompt in the training dataset. In some embodiments, the system trains the universal model by predicting a duration of each phoneme in the new text (e.g., using duration predictor model 504). The predicted durations are used in generating the synthesized speech by determining a temporal alignment (e.g., using alignment model 508) between the phonemes and the reference audio. The system can adjust the duration of each phoneme in the synthesized speech in accordance with the predicted durations to emulate the acoustic properties of the reference audio in accordance with the linguistic features of the new text. For example, the model can perform the alignment on a per-sample basis, iterating through each audio sample in the dataset and aligning its acoustic properties with the linguistic features extracted from the corresponding text prompt. By aligning the two modalities, the model learns to recognize patterns and relationships that facilitate accurate speech synthesis. Methods of aligning the two modalities are discussed in greater detail with reference to FIG. 5.

In step 606, the system receives an input (e.g., user input) including a reference audio and new text. The reference audio and the new text are not included within the training dataset, and the new text is not a transcription of the reference audio. Example reference text prompts 404 are illustrated and described in more detail with reference to FIG. 4.

In step 608, the system uses the alignment information and the user input to generate, by the universal model, synthesized speech emulating the acoustic properties of the reference audio in accordance with the linguistic features of the new text. To generate the synthesized speech, the system can use one or more of the models within the UVM 502 discussed in further detail in FIG. 5.

In some embodiments, the universal model can extract spectral and temporal features from the reference audio. The universal model transforms the spectral and temporal features into a compressed representation, and discretizes the compressed representation into acoustic tokens at a specified bitrate (e.g., using audio shape transformer model 506). The universal model maps the acoustic tokens to the linguistic features of the new text. Using the acoustic tokens and the linguistic features, the universal model modulates a waveform representative of the acoustic tokens and the linguistic features. The universal model generates the synthesized speech using the modulated waveform. For example, the universal model uses the audio shape transformer model 506 to compress the audio waveform of the reference audio, as discussed in further detail with reference to FIG. 5.

In some embodiments, the universal model compares phonetic transcriptions of the new text and the acoustic tokens of the reference audio. The universal model generates an alignment matrix using the comparison. Each element in the alignment matrix corresponds to an index of a voiced phoneme of the reference audio at a current timestep of the reference audio. For example, the universal model can use the alignment model 508 to generate the alignment matrix from the reference audio and reference text input, as discussed in further detail with reference to FIG. 5.

In some embodiments, the universal model parses through the new text and the alignment matrix and identifies coarse acoustic tokens from the acoustic tokens. The coarse acoustic tokens are representative of the new text in accordance with the alignment matrix. The universal model adjusts parameters of the synthesized speech based on the coarse acoustic tokens. For example, the universal model can use the text-to-coarse audio model 510 to generate coarse acoustic tokens using the acoustic tokens discussed in further detail with reference to FIG. 5.

Using the coarse acoustic tokens, the universal model generates refined acoustic tokens by iteratively adjusting the acoustic tokens to match the acoustic properties of the new text. The refined acoustic tokens are used in generating the synthesized speech by modulating the parameters of the synthesized speech based on the refined acoustic tokens. For example, the universal model uses the coarse-to-fine audio model 512 to generate refined acoustic tokens using the coarse acoustic tokens, as discussed in further detail with reference to FIG. 5.

In some embodiments, the universal model is stored in a cloud environment hosted by a cloud provider with scalable resources or a self-hosted environment hosted by a local server. In a cloud environment, the universal model has the scalability of cloud services provided by platforms (e.g., AWS™, Azure™). Storing the universal model in a cloud environment entails selecting the cloud service, provisioning resources dynamically through the provider's interface or APIs, and configuring networking components for secure communication. Cloud environments allow the universal model to scale storage capacity without the need for manual intervention. As the demand for storage space grows, additional resources can be automatically provisioned to meet the increased workload. Additionally, cloud-based caching modules can be accessed from anywhere with an internet connection, providing convenient access to historical data for users across different locations or devices.

Conversely, in a self-hosted environment, the universal model is stored on a private web server. Deploying the universal model in a self-hosted environment entails setting up the server with the necessary hardware or virtual machines, installing an operating system, and storing the universal model. In a self-hosted environment, organizations have full control over the universal model, allowing organizations to implement customized security measures and compliance policies tailored to the organization's specific needs. For example, organizations in industries with strict data privacy and security regulations, such as finance institutions, can mitigate security risks by storing the universal model in a self-hosted environment.

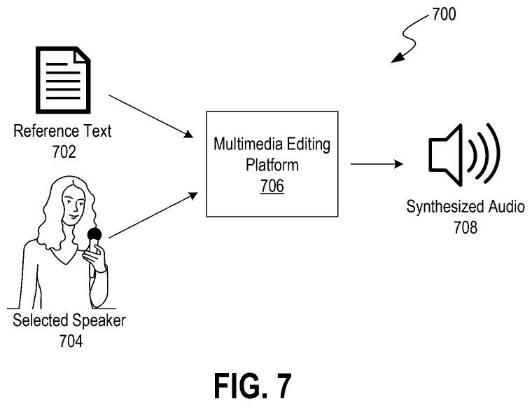

FIG. 7 is a block diagram illustrating an example environment 700 for assigning a speaker to create synthesized speech. The example environment 700 includes reference text 702, selected speaker 704, multimedia editing platform 706, and synthesized audio 708. Multimedia editing platform 706 may be the same as the media production platform 102 and media production platform 210 illustrated and described in more detail with reference to FIGS. 1 and 2, respectively. Alternatively, the multimedia editing platform 706 may be implemented by, or accessible to, the media production platform 102 and media production platform 210 illustrated and described in more detail with reference to FIGS. 1 and 2, respectively. The example environment 700 can be implemented using components of the example computer system 2000 illustrated and described in more detail with reference to FIG. 20. Likewise, embodiments of the example environment 700 can include different and/or additional components that can be connected in different ways.

The reference text 702 is the textual input that encapsulates the linguistic content to be converted into synthesized speech. The reference text is provided by the user or generated programmatically based on specific requirements or inputs. Example reference texts 702 are illustrated and described in more detail with reference to FIG. 4. The user or system operator can select speaker 704 from a predefined set of available options, representing the desired voice characteristics and style for the synthesized speech output. For example, a speaker selection menu may include options such as gender, age, accent, and tone. The user can choose the speaker that best aligns with the desired qualities for the synthesized speech.

In some embodiments, instead of selecting a speaker from a predefined set, the system may allow for the customization of voice characteristics. Users could adjust parameters such as pitch, speech rate, and vocal timbre to tailor the synthesized speech to their preferences. The level of customization offers greater flexibility in creating synthesized speech outputs that meet specific requirements or preferences. Furthermore, the multimedia editing platform 706 can incorporate additional features and functionalities to enhance the synthesis process, such as voice customization options and/or real-time audio preview capabilities. By providing users with intuitive tools for speaker selection and speech synthesis, the platform empowers content creators to create audio content easily and with precision.

Upon selection, the selected speaker 704 is input into the multimedia editing platform 706. Using the selected speaker 704 as a reference, the multimedia editing platform 706 transforms the textual content encapsulated within the reference text 702 into synthesized audio 708. The selected speaker characteristics are applied during this synthesis process to ensure that the synthesized speech output aligns with the chosen voice style. For example, the universal model can generate the synthesized speech output using an audio sample of the selected speaker and the reference text, as discussed in further detail with reference to FIGS. 3-6. The synthesized audio 708 emulates the voice characteristics and style attributed to the selected speaker 704.

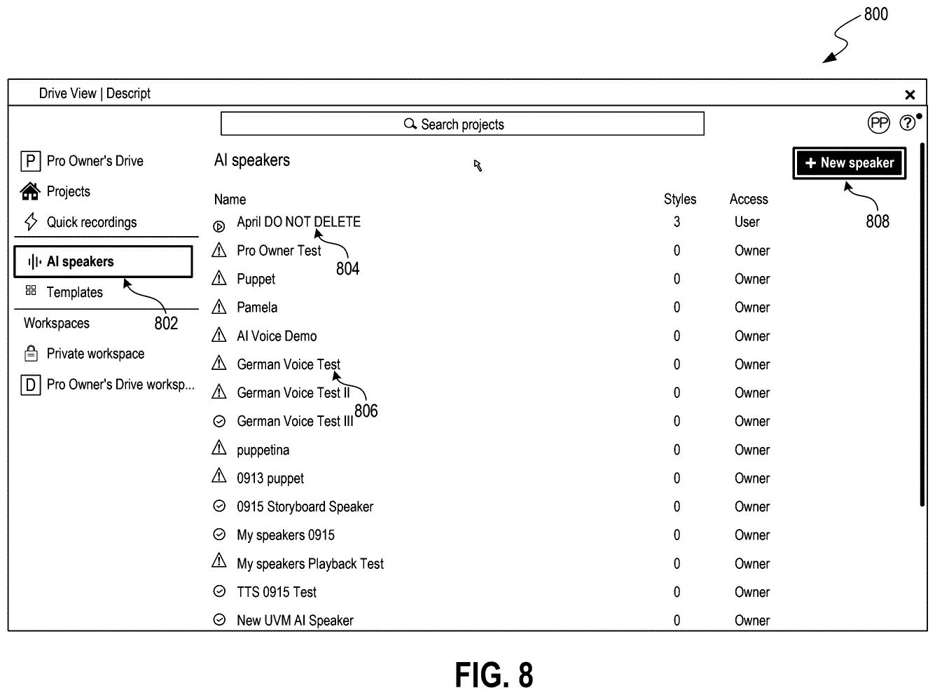

FIG. 8 depicts an example interface 800 for adding a new speaker to the set of available speakers. The example interface 800 includes AI-generated speakers 802, available speakers 804, non-available speakers 806, and button 808. The example interface 800 can be implemented using components of the example computer system 2000 illustrated and described in more detail with reference to FIG. 20. For example, the example interface 800 can be implemented using the media production platform front-end 304 illustrated and described in more detail with reference to FIG. 3. Likewise, embodiments of the example interface 800 can include different and/or additional components that can be connected in different ways.

The AI-generated speakers 802 represent a variety of synthetic voices capable of emulating various linguistic styles and vocal characteristics. Accompanying the AI-generated speakers 802 can be existing available speaker 804 options, representing a selection of human and/or synthetic voices that users can use for their audio projects. Each available speaker 804 embodies unique vocal traits and stylistic nuances, thereby catering to different preferences and requirements in speech synthesis.

In contrast, the non-available speakers 806 denotes speakers that are currently unavailable for selection within the interface 800. The speakers can be, for example, undergoing maintenance, refinement, and/or validation processes, rendering the non-available speakers 806 temporarily inaccessible to users until the non-available speakers 806 meet predefined quality and/or compatibility standards. A button 808 allows users to introduce new voices into the platform. The button 808 triggers a series of backend processes and/or user interactions to collect and integrate new speaker data into the multimedia editing platform.

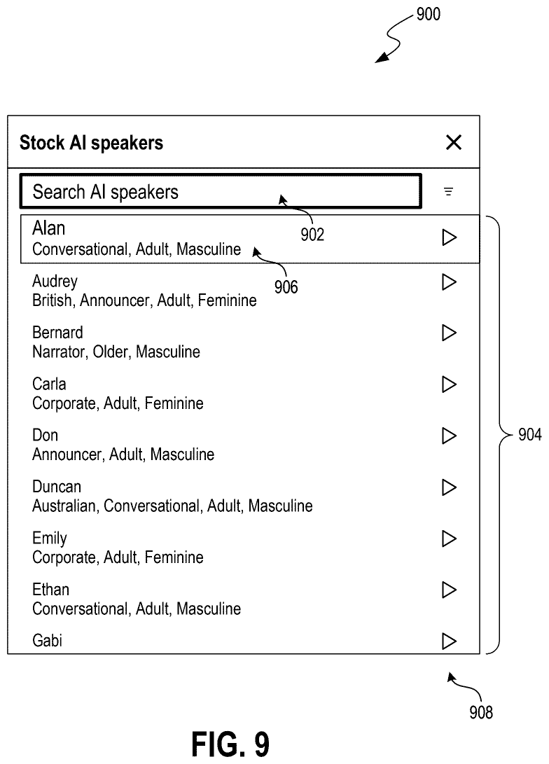

FIG. 9 depicts an example interface 900 for selecting a speaker from a set of predefined speakers. The example interface 900 includes search bar 902, speaker profiles 904, selected profile 906, and play button 908. The example interface 900 can be implemented using components of the example computer system 2000 illustrated and described in more detail with reference to FIG. 20. For example, the example interface 900 can be implemented using the media production platform front-end 304 illustrated and described in more detail with reference to FIG. 3. Likewise, embodiments of the example interface 900 can include different and/or additional components that can be connected in different ways.

A search bar 902 enables users to quickly locate specific speakers by entering relevant keywords or criteria. The search functionality of the search bar 902 allows users to efficiently navigate through a potentially extensive list of available options. Displayed within the interface 900 are various speaker profiles 904, each representing a distinct voice character with unique linguistic attributes and vocal characteristics. The speaker profiles 904 visually represent the available speakers, providing users with valuable information to inform the user's selection decisions. Users can browse through the list of speakers, evaluate their respective attributes (e.g., conversational, adult, masculine), and compare them to identify the most suitable option. Upon selecting a speaker, the corresponding selected profile 906 can become highlighted or otherwise visually distinguished, indicating the user's choice. The selected profile 906 serves as a reference point for subsequent actions, such as previewing the speaker's voice or initiating audio generation. To assist users in evaluating speaker options, the interface 900 can include a play button 908 associated with each speaker profile. By clicking on the play button 908, users access a sample audio clip showcasing the selected speaker's voice in action. The feature allows users to audition different voices directly within the interface, enabling them to assess the voice's suitability for their specific audio requirements.

FIGS. 10A-10C depict an example interface 1000 for selecting a segment of text in the transcript to regenerate audio and allowing playback of the regenerated audio. The example interface 1000 includes specific text segments 1002 and interactive indicator 1004. The example interface 1000 can be implemented using components of the example computer system 2000 illustrated and described in more detail with reference to FIG. 20. For example, the example interface 1000 can be implemented using the media production platform front-end 304 illustrated and described in more detail with reference to FIG. 3. Likewise, embodiments of the example interface 1000 can include different and/or additional components that can be connected in different ways.

FIG. 10A depicts an example interface 1000 for selecting a segment of text in the transcript to regenerate audio. The interface presents users with a visual representation of the transcript, with individual text segments displayed for user interaction. In the displayed transcript, specific text segments 1002 can be highlighted, indicating areas where users desire to initiate the regeneration of audio. An interactive indicator 1004 can be provided within the interface to enable users to identify and select the segment of text they wish to regenerate audio for. Upon selecting the specific text segment 1002 and interacting with the interactive indicator 1004, the corresponding audio associated with the specific text segment 1002 can be replaced. Users can dynamically update or modify audio content based on changes made to the transcript to ensure synchronization between the textual and audio elements of the multimedia project.

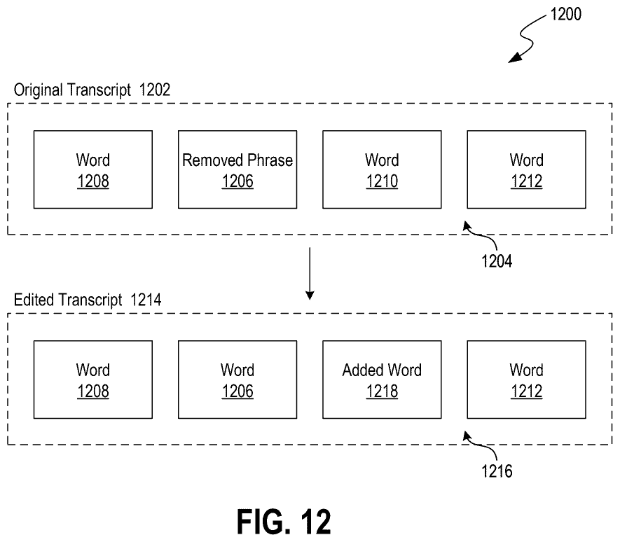

FIG. 10B depicts an example interface 1000 for regenerating audio for a selected segment of text in the transcript. Similar to FIG. 10A, interface 1000 presents users with a visual representation of the transcript, with individual text segments displayed for user interaction. The interactive indicator 1004 includes interactive functionalities (e.g., via a drop-down menu), which contain additional options and functionalities, such as a regeneration indicator 1006 related to regenerating the specific text segment 1002. For example, a “regenerate” button acts as a trigger for initiating audio regeneration. By selecting the “regenerate” button, users signal their intent to generate new audio content corresponding to the selected text segment, thereby updating or replacing the existing audio associated with the highlighted text. For example, the regenerated audio (e.g., synthesized speech) is generated using a universal model illustrated and described in more detail with reference to FIG. 12.

FIG. 10C depicts an example interface 1000 allowing playback of the regenerated audio for the selected segment of text in the transcript. Upon regeneration, users can be provided with a range of additional options to refine and/or validate the regenerated audio. An undo option 1008 offers users the flexibility to revert the replacement audio to the original state. Furthermore, a play button 1010 allows users to preview the regenerated audio, facilitating real-time assessment and validation of the audio quality. To ensure accuracy and consistency, a refresh button 1012 enables users to update the regenerated audio based on any subsequent edits or modifications made to the text. Once satisfied with the regenerated audio, users can confirm their selection using a confirmation button 1014, approving the replacement of the original audio with the regenerated version.

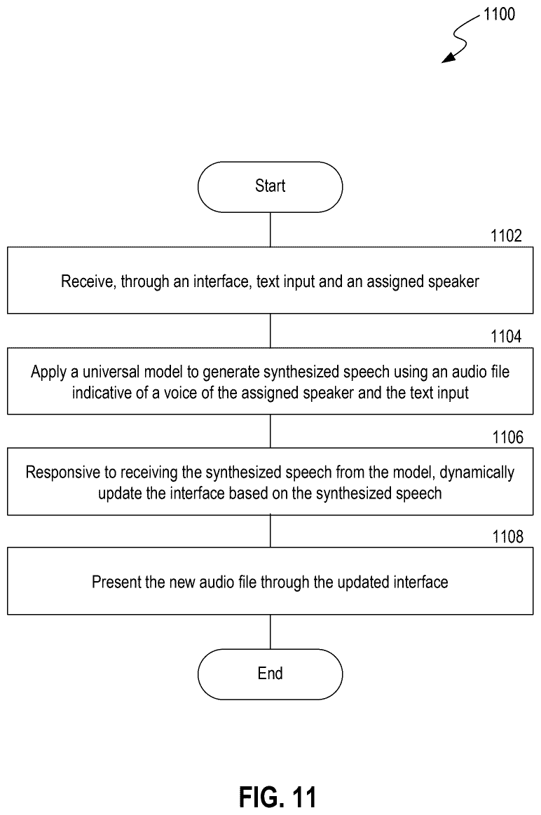

FIG. 11 depicts a flow diagram of a process 1100 for text-to-speech using an assigned speaker and a universal variable model. In one example, the process 1100 is performed by a computer system such as a media production platform (e.g., the media production platform 102 in FIG. 1, the media production platform 210 in FIG. 2, the multimedia editing platform 706 in FIG. 7) to generate the synthesized speech. In some embodiments, the process 1100 is performed by a computer system, e.g., computer system 2000 illustrated and described in more detail with reference to FIG. 20. Likewise, embodiments can include different and/or additional steps or can perform the steps in different orders.

In step 1102, the system receives, through an interface (e.g., user interface), text input and an assigned speaker. The input includes the text that the user wants to convert into speech and the assigned speaker chosen by the user. The user interface can be designed using graphical elements such as text boxes, dropdown menus, or voice command interfaces, allowing users to input the desired text and select the preferred speaker from a list of available options. For example, a graphical user interface (GUI) presents users with a text input field where the users can type or paste the desired text. Additionally, the GUI can include a dropdown menu or a list of available speakers from which users choose. Each speaker option can be accompanied by relevant information such as the speaker's name, gender, accent, and any other distinguishing characteristics. Users then select their preferred speaker by clicking on the corresponding option in the list. In some embodiments, the system provides users with a voice command interface where they can speak the text they want to convert into speech and verbally specify their chosen speaker. The system uses speech recognition technology to transcribe the user's spoken input into text and identify the selected speaker based on the verbal command.

In step 1104, the system applies a universal model to generate synthesized speech using an audio file indicative of a voice of the assigned speaker and the text input. The universal model is the same as or similar to UVM 306 and UVM 406 illustrated and described in more detail with reference to FIGS. 3 and 4 respectively. Methods and algorithms used by the universal model to produce synthesized speech outputs are illustrated and described in more detail with reference to FIGS. 4-7.

The system can generate the synthesized speech by supplying an input associated with the text input and the audio file into the universal model. The text input contains linguistic features and content to be expressed in speech form, while the audio file provides acoustic properties specific to the assigned speaker's voice. Subsequent to supplying the input to the model, the system receives synthesized speech generated by a model (e.g., the universal model). Further examples of the model used to generate the synthesized speech are detailed in FIGS. 3 and 4. The emulates the voice of the assigned speaker in accordance with the linguistic features of the text input. Further examples of synthesized speech are discussed with reference to FIG. 4.

In some embodiments, prior to supplying the input to the universal model, the system converts the audio file representing the voice of the assigned speaker into a frequency domain format. The system use a Fourier transform to decompose the audio file into its constituent frequencies (e.g., a combination of sinusoidal components). The transformation yields a representation of the audio signal in terms of its frequency components, which allows the model to extract relevant acoustic features based on the audio file's frequency components. For example, the audio file can be converted into a magnitude spectrogram, which provides a visual representation of the frequency content of the audio signal over time. In a magnitude spectrogram, the amplitude of each frequency component is represented by the intensity of a corresponding pixel or element in a two-dimensional matrix, with time represented along one axis and frequency along the other. By converting the audio file into a frequency domain and using the converted file as an input in the model, the model can capture patterns and nuances in the voice of the assigned speaker used for producing natural-sounding speech. This includes aspects such as pitch, intonation, and timbre, which help convey meaning and emotion in speech.

In step 1106, responsive to receiving the synthesized speech from the model, the system can dynamically update the interface based on the synthesized speech. The dynamic update of the interface can include adjusting various elements based on the characteristics of the synthesized speech. For example, visual cues such as progress bars, waveform displays, or text highlighting may be modified to reflect the ongoing speech generation process. The adjustments provide users with real-time feedback on the progress of speech synthesis. Additionally, the interface update may involve changes in layout or design to accommodate the synthesized speech content. For instance, if the length or complexity of the synthesized speech varies, the interface may dynamically adjust the display to ensure optimal readability and user comprehension. Furthermore, the dynamic interface update can incorporate interactive elements that allow users to control or customize aspects of the synthesized speech in real-time. For example, users may have the option to adjust the speech rate, volume, or intonation while the speech is being generated.

In step 1108, the system presents the new audio file through the updated interface. The systems ensures that the generated speech waveform is in an audible format that can be played back to the user. The synthesized speech can be stored as a digital audio file or streamed in real-time. The user interface provides a platform for users to interact with the synthesized speech and may include playback controls such as play, pause, stop, and volume adjustment. Example user interfaces are illustrated and described in more detail with reference to FIGS. 10A-C.

In some embodiments, the system displays visual cues indicating pauses, intonations, and/or emphasis in the user interface alongside the synthesized speech. For example, a waveform visualization of the speech signal can be displayed, with pauses represented by flat segments and intonations or emphasis indicated by variations in the waveform's amplitude or frequency. The visualization allows users to better understand the prosodic aspects of the synthesized speech and provides additional context for interpretation.

The system can display the text input and corresponding synthesized speech in the user interface, and dynamically updates the user interface as the synthesized speech is generated. As the synthesized speech is generated in real-time, the user interface dynamically updates to reflect the current portion of the text being spoken. The synchronized display enables users to follow along with the text as the text is spoken, helping users comprehend the content more effectively.

In some embodiments, the system provides a set of options related to parameters of the synthesized speech, such as pitch, speed, and/or emphasis. The system can receive a selected option within the set of options to modify the parameters of the synthesized speech. In response, the system modifies the parameters of the synthesized speech based on the selected option. The user interface can be designed to display sliders, dropdown menus, or input fields for each parameter, allowing users to adjust them according to their preferences. For example, a slider controls the pitch, another slider adjusts the speed, and checkboxes or dropdown menus allow users to select different emphasis styles.

Upon receiving a selected option within the set of options from the user interface, the system can trigger a recalculation of the acoustic features of the synthesized speech based on the selected option. For instance, if the user adjusts the pitch parameter to make the speech sound higher or lower, the system modifies the pitch of the speech waveform, altering the waveform's frequency accordingly. Similarly, if the user changes the speed parameter to make the speech faster or slower, the system adjusts the duration of each phonetic segment in the speech accordingly. In some embodiments, the system pre-computes multiple versions of the synthesized speech with different parameter settings. For example, the system generates and stores multiple versions of the synthesized speech corresponding to different parameter combinations (e.g., prosodic parameters that include variations in pitch contour, speech rate, and/or vocal intensity) during the initial synthesis process. When a user selects a specific option, the system retrieves (e.g., from a database where the versions are stored) the pre-generated version corresponding to that option and presents the version to the user. The approach can reduce computational load during runtime.

In some embodiments, the system presents a selection of available voices of the assigned speaker in the user interface. The system receives a selected voice from the presented selection, and assigns the selected voice to the assigned speaker. The information may be stored in a database or a configuration file, containing details such as voice name, gender, accent, and language. The system retrieves this information and populates the user interface with a list or grid displaying the available voices for the assigned speaker. Upon receiving a selected voice from the presented selection, the system captures the user's choice through the user interface interaction. The selection event triggers a process within the system to assign the selected voice to the assigned speaker. The system updates the configuration or settings associated with the assigned speaker to reflect the newly selected voice. This may involve updating a database entry, configuration file, or in-memory data structure with the identifier of the chosen voice.

In some embodiments, the system stores previous versions of the synthesized speech as an audio file in a cache. Methods of storing in a cache are illustrated and described in more detail with reference to FIG. 6.

When the system receives an edited text input, the system can compare a new text input with the previously submitted text input and identify any differences or modifications. In response to receiving the edited text input, the system triggers the regeneration of the synthesized speech based on the edited text input. The regeneration can include updating the acoustic properties of the synthesized speech in accordance with the linguistic features of the edited text input.

FIG. 12 is a block diagram illustrating an example environment 1200 for editing a transcript to add and/or delete text. The example environment 1200 includes original transcript 1202, original text content 1204, undesired segments 1206, words 1208, 1210, 1212, edited transcript 1214, new text content 1216, and new segment 1218. The example environment 1200 can be implemented using components of the example computer system 2000 illustrated and described in more detail with reference to FIG. 20. Likewise, embodiments of the example environment 1200 can include different and/or additional components that can be connected in different ways.

The original transcript 1202 contains the original text content 1204. The original text content 1204 includes words (e.g., words 1208, 1210, 1212). The original text content may consist of individual words or segments of text that the user wishes to preserve without modification. The words or segments could be identified based on specific criteria defined by the user. The original transcript 1202 contains the raw text content (e.g., original text content 1204) derived from the spoken source material. The original text content 1204 may include spoken words, sentences, or dialogue captured verbatim from audio recordings or live speech events. The system can present the original transcript in a visually accessible format within the user interface.

Within the original transcript 1202, users may be able to modify the original transcript 1202 directly. In some embodiments, modifications to the original transcript 1202 are visually highlighted in some manner. For example, newly added text may be highlighted in a particular color to indicate that audio must still be recorded for that text. Examples of modifications include additions of new text, removals of existing text, and changes to existing text. Users can identify undesired segments 1206, or specific segments or phrases the user wishes to remove from the original transcript 1202. The interface allows users to view the transcript text and interact with the text effectively. For example, the interface can include features such as text highlighting, scrolling functionality, and zooming options to facilitate navigation and selection of segments. For example, the undesired segment 1206 can be highlighted within the original text content 1204, signifying the user's intention to delete this particular segment and helping distinguish the selected segments from the rest of the transcript.

The system can generate an edited transcript 1214 with new text content 1216 that contains both retained and modified text elements. The system identifies and captures the text elements that the user modified or added to the edited transcript. This includes analyzing the differences between the original and edited versions of the transcript to pinpoint the specific segments that were altered. New text content 1216 may include revised sentences, newly inserted content, or partially edited phrases. The system includes the retained text segments from the original transcript alongside the modified or newly added content from the user's edits. Users can also introduce new segment 1218 while simultaneously removing undesired segment 1206 from the original text. The undesired segments 1206 are absent from the edited transcript 1214.

With the edited transcript 1214, the system generates synthesized speech for the new segments 1218 and removes the synthesized speech of the undesired segments 1206 using a universal model. The universal model is the same as or similar to UVM 306 and UVM 406 illustrated and described in more detail with reference to FIGS. 3 and 4 respectively. Methods and algorithms used by the universal model to produce synthesized speech outputs are illustrated and described in more detail with reference to FIGS. 4-7.

FIGS. 13A-13B depict an example interface 1300 for smoothing audio of an updated transcript. The example interface 1300 can be implemented using components of the example computer system 2000 illustrated and described in more detail with reference to FIG. 20. For example, the example interface 1300 can be implemented using the media production platform front-end 304 illustrated and described in more detail with reference to FIG. 3. Likewise, embodiments of the example interface 1300 can include different and/or additional components that can be connected in different ways.

FIG. 13A depicts an example interface 1300 before smoothing audio of an updated transcript. The interface 1300 presents users with a visual representation of the transcript that includes the textual content 1302. Embedded within the textual content 1302 is a text indicator 1304 signifying a specific point or segment where the user intends to heal or smooth the corresponding audio. The text indicator serves as a visual cue for users to pinpoint areas in the transcript that need audio adjustment, such as removing glitches, reducing noise, or improving transitions between segments. The user selects a designated point or segment in the transcript where audio smoothing is desired. This can include, for example, clicking, tapping, or otherwise selecting the text indicator 1304 associated with a target segment.

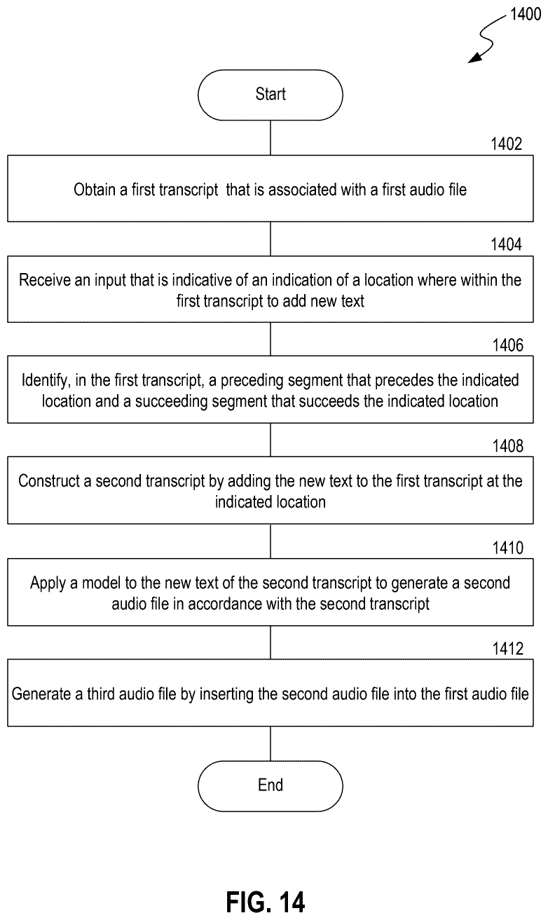

In response to the user's interaction with the interface, a healing indicator 1306 offers users the opportunity to initiate the audio smoothing process at the designated text indicator 1304. Once the user confirms their intention by interacting with the healing indicator, the system smooths the audio at the designated point in the transcript using a universal model. For example, the universal model can generate synthesized speech for the indicated segment to improve the coherence and audio quality surrounding the indicated segment by aligning the acoustic properties of the synthesized speech with that of the preceding and subsequent segments, as discussed further with reference to FIG. 14. The universal model is the same as or similar to UVM 306 and UVM 406 illustrated and described in more detail with reference to FIGS. 3 and 4 respectively. Methods and algorithms used by the universal model to produce synthesized speech outputs are illustrated and described in more detail with reference to FIGS. 4-7.

FIG. 13B depicts an example interface 1300 after smoothing audio of an updated transcript. Following the healing of the audio associated with the healing indicator 1306, the interface 1300 can present users with several interactive options to manage and review the healed audio output, which can be visually indicated using highlight 1308.

An undo option 1310 enables users to revert the healed audio back to a previous state in the event of undesired changes or errors. The functionality provides users with a safeguard against unintended modifications, allowing for greater flexibility and control over the editing process. A play option 1312 allows users to preview the healed audio output directly within the editing environment. The playback functionality enables users to assess the effectiveness of the audio smoothing process and make any necessary adjustments or refinements as needed. To ensure real-time updates and synchronization with the edited transcript, the interface can provide a refresh option 1314 that enables users to refresh the audio output display. The interface 1300 can include a confirmation option 1316 that allows users to approve the healed audio and replace the original audio with the smoothed version. By providing this option, users can finalize their edits if the healed audio output accurately reflects their intended modifications and enhancements.

FIG. 14 depicts a flow diagram of a process 1400 for smoothing audio after adding or deleting text to/from an underlying transcript of the audio. In one example, the process 1400 is performed by a computer system such as a media production platform (e.g., the media production platform 102 in FIG. 1, the media production platform 210 in FIG. 2, the multimedia editing platform 706 in FIG. 7) to generate the synthesized speech. In some embodiments, the process 1400 is performed by a computer system, e.g., computer system 2000 illustrated and described in more detail with reference to FIG. 20. Likewise, embodiments can include different and/or additional steps or can perform the steps in different orders.

In step 1402, the system obtains an original transcript (e.g., a first transcript) associated with an original audio (e.g., a first audio file). The original transcript is the same as or similar to original transcript 1202 illustrated and described in more detail with reference to FIG. 12. In step 1404, the system receives an input that is indicative of an indication of a location where within the first transcript to add new text. The indicator is the same as or similar to text indicator 1304 illustrated and described in more detail with reference to FIGS. 13A and 13B.

In step 1406, the system identifies, in the first transcript, a preceding segment that precedes the indicated location and a succeeding segment that succeeds the indicated location. The system determines the boundaries of the preceding and succeeding segments based on the position of the indicator within the transcript. For example, the starting and ending points of each segment can depend on predetermined factors such as sentence boundaries, paragraph breaks, or other structural cues present in the transcript. In step 1408, the system constructs an updated transcript (e.g., a second transcript) by adding the new text to the original transcript at the indicated location. The system inserts the new text between the preceding and succeeding segments identified in step 1406.

In step 1410, the system applies and/or directs a universal model to generate healing audio (e.g., a second audio file) in accordance with the updated transcript. The universal model determines alignment information that aligns acoustic properties of the original audio with linguistic features of the original transcript. The universal model is the same as or similar to UVM 306 and UVM 406 illustrated and described in more detail with reference to FIGS. 3 and 4 respectively. Methods and algorithms used by the universal model to produce synthesized speech outputs are illustrated and described in more detail with reference to FIGS. 4-7. The healing audio emulates the acoustic properties of the original audio in accordance with the linguistic features of the new text, the preceding segment of the indicator, and the succeeding segment of the indicator. In some embodiments, the system validates the healing audio against the original audio by comparing the acoustic properties of the healing audio with the acoustic properties of the original audio to detect discrepancies. In response to the detected discrepancies between the acoustic properties of the healing audio and the acoustic properties of the original audio not exceeding a predetermined threshold, the system generates the smoothed audio.

In step 1412, the system generates a smoothed audio (e.g., a third audio file) by inserting the healing audio into the original audio, where the healing audio replaces a corresponding portion of the original audio associated with the preceding segment and the succeeding segment, or removing the text associated by the indicator. The system aligns the timing and duration of the healing audio with corresponding portions of the original audio when inserting the healing audio into the original audio. In some embodiments, the smoothed audio is generated in response to receiving a subsequent user input associated with accepting the healing audio. In some embodiments, generating the smoothed audio includes blending the healing audio with the original audio by adjusting the amplitude and frequency of the healing audio to match the amplitude and the frequency of the original audio. In some embodiments, the system displays visual cues or markers within a user interface to indicate segments of the original transcript modified.

In some embodiments, the system stores previous versions of the original audio, the healing audio, the smoothed audio, the original transcript, and/or the updated transcript in a cache. Methods of storing in a cache are illustrated and described in more detail with reference to FIG. 6.

In some embodiments, the system receives a subsequent user input associated with removing the new text from the updated transcript, and automatically restores the original transcript and the original audio.

In some embodiments, the system provides a recommendation of the selected segment of text to delete within the original transcript. The system can identify redundant segments of text within the original transcript using a frequency and distribution of words or phrases within the original transcript, and generate the recommendation of the selected segment based on linguistic analysis, context comprehension, and/or user preferences associated with the redundant segments of text. Words or phrases that appear disproportionately compared to others may indicate redundancy. By maintaining a count of word frequencies, the system can identify segments with high repetition rates above a predetermined threshold, suggesting potential candidates for deletion. For example, segments that are concentrated in specific sections or contexts may be considered redundant if they contribute little to the overall diversity or informativeness of the text. Analyzing distribution patterns helps identify clusters of redundant content.

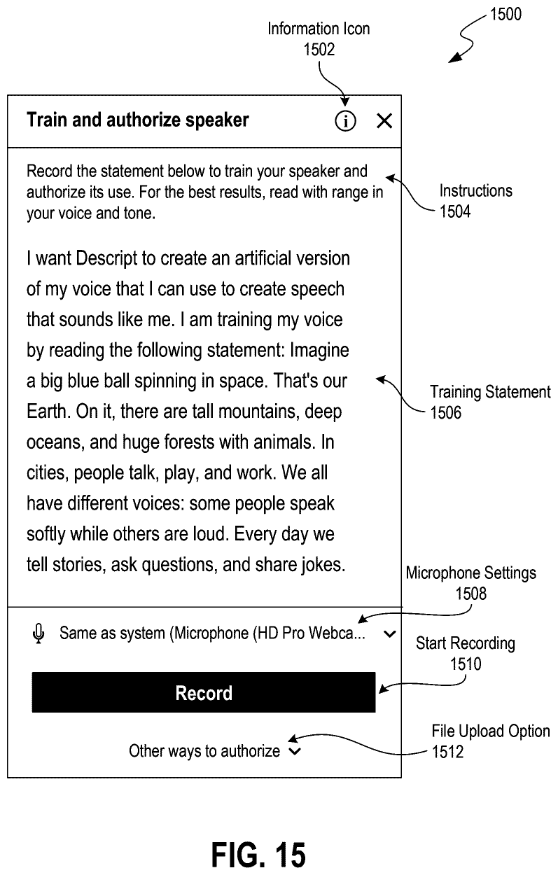

FIG. 15 depicts an example interface 1500 for a training statement for generating synthesized speech. The example interface 1500 includes information icon 1502, instructional text 1504, training statement field 1506, microphone settings 1508, recording button 1510, and file upload option 1512. The example interface 1500 can be implemented using components of the example computer system 2000 illustrated and described in more detail with reference to FIG. 20. For example, the example interface 1500 can be implemented using the media production platform front-end 304 illustrated and described in more detail with reference to FIG. 3. Likewise, embodiments of the example interface 1500 can include different and/or additional components that can be connected in different ways.

An information icon 1502 can provide users with contextual guidance and instructions regarding the training statement setup. The information icon 1502 (e.g., an “i” signal) serves as a reference point for users seeking additional information or clarification on the training process and the process's requirements. Beneath the information icon 1502, instructional text 1504 outlines the steps users need to follow to successfully record their voice for synthesized speech generation. The instructions prompt users to read a provided training statement aloud, and can suggest, for example, the importance of maintaining vocal range and tone diversity for optimal results.

The training statement field 1506 allows users to view the text of the statement they are required to read aloud for training purposes. The statement serves as the basis for training the speaker model and capturing the vocal characteristics and nuances necessary for accurate speech synthesis. Microphone settings 1508 allow users to configure and adjust their microphone input parameters to ensure optimal recording quality and accuracy.

To initiate the recording process, users can utilize the recording button 1510, which triggers the microphone to capture their spoken rendition of the training statement. The functionality enables users to generate personalized training data directly within the platform, streamlining the speaker training process. For users who prefer to upload pre-recorded audio files for training purposes, the interface offers a file upload option 1512. The feature allows users to import existing audio recordings of the training statement.

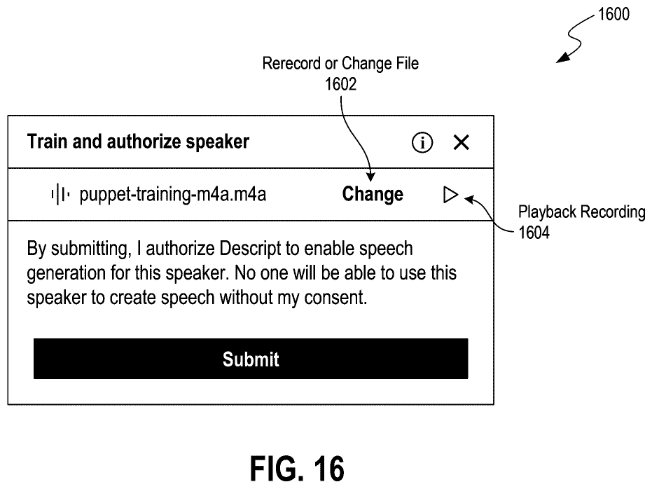

FIG. 16 depicts an example interface 1600 for an authorization statement for generating synthesized speech. The example interface 1600 includes modification option 1602 and a playback option 1604. The example interface 1600 can be implemented using components of the example computer system 2000 illustrated and described in more detail with reference to FIG. 20. For example, the example interface 1600 can be implemented using the media production platform front-end 304 illustrated and described in more detail with reference to FIG. 3. Likewise, embodiments of the example interface 1600 can include different and/or additional components that can be connected in different ways.

A modification option 1602 (e.g., a “Modify” button or edit icon) provides users with the flexibility to rerecord their authorization statement or make changes to previously uploaded voice recordings. When users choose to modify their authorization statement, the system prompts them to record a new statement or select a previously uploaded recording for editing. The feature enables users to review and refine their authorization statement as needed to ensure clarity and accuracy before proceeding with the authorization process.

For users who wish to review their recorded voice data before providing authorization, the interface 1600 can provide a playback option 1604 that allows users to listen to a playback of their voice recording. The functionality enables users to assess the quality and suitability of their recorded voice data and verify that the voice data aligns with their intended authorization statement.

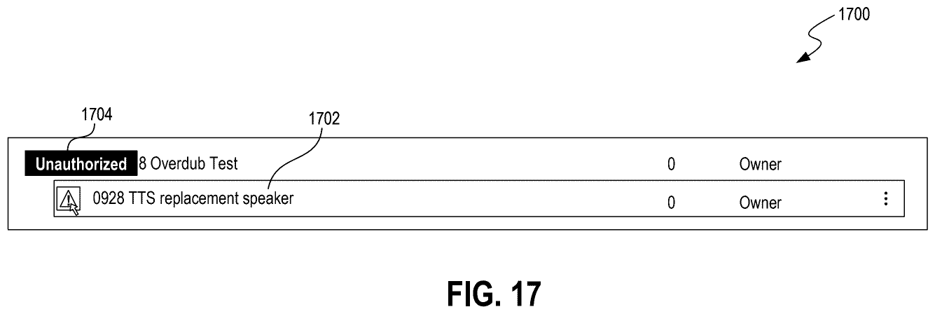

FIG. 17 depicts an example interface 1700 of an unauthorized speaker. The example interface 1700 includes speaker identifier 1702 and an unauthorized indicator 1704. The example interface 1700 can be implemented using components of the example computer system 2000 illustrated and described in more detail with reference to FIG. 20. For example, the example interface 1700 can be implemented using the media production platform front-end 304 illustrated and described in more detail with reference to FIG. 3. Likewise, embodiments of the example interface 1700 can include different and/or additional components that can be connected in different ways.

The speaker identifier 1702 can display, for example, a given name or identifier of the speaker associated with a particular segment of audio or text within the platform. The speaker identifier 1702 can serve as a visual cue to identify the speaker whose authorization status is being conveyed. The system may retrieve speaker information from user profiles or metadata associated with the audio recordings, or users may manually input speaker identifiers when uploading content to the platform.

The unauthorized indicator 1704 visually communicates that the speaker's status is currently unauthorized within the platform. The unauthorized indicator 1704 can consist of a symbol, icon, or text label explicitly stating “unauthorized” to convey the speaker's status to users interacting with the interface. When users encounter the unauthorized indicator, they are alerted to the fact that the associated speaker lacks the necessary authorization or consent to utilize their voice data for speech synthesis purposes within the platform. The system can ensure that the speaker identifier and unauthorized indicator are dynamically updated based on changes in the authorization status of speakers. For example, if a speaker provides consent or authorization for their voice data to be used within the platform, the unauthorized indicator is replaced with an authorized indicator. Similarly, if a speaker's authorization status changes from authorized to unauthorized, the corresponding indicator is updated accordingly.

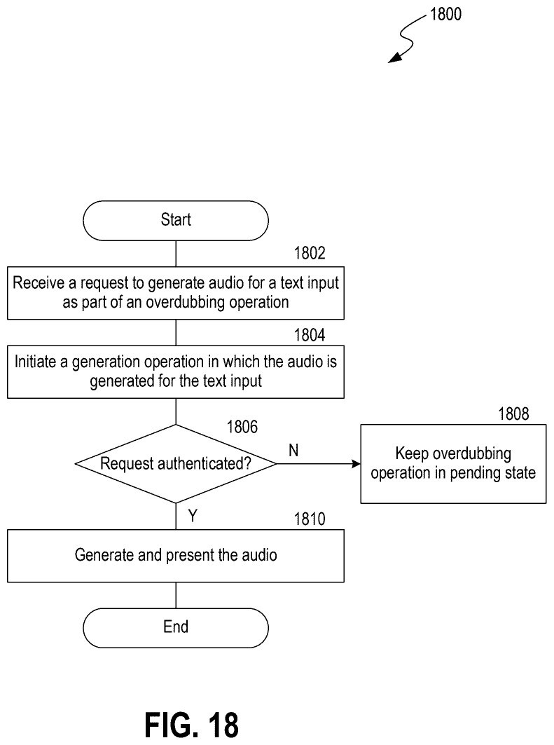

FIG. 18 depicts a flow diagram of a security process 1800 implemented when generating synthesized speech. In one example, the process 1800 is performed by a computer system such as a media production platform (e.g., the media production platform 102 in FIG. 1, the media production platform 210 in FIG. 2, the multimedia editing platform 706 in FIG. 7) to generate the synthesized speech. In some embodiments, the process 1800 is performed by a computer system, e.g., computer system 2000 illustrated and described in more detail with reference to FIG. 20. Likewise, embodiments can include different and/or additional steps or can perform the steps in different orders.

In step 1802, the system receives a request to generate audio for a text input as part of an overdubbing operation. The audio is the same as or similar to synthesized speech and synthesized audio 708 illustrated and described in more detail with reference to FIGS. 6 and 7 respectively. The text input is the same as or similar to new text content 1216 illustrated and described in more detail with reference to FIG. 12.

In step 1804, the system initiates a generation operation in which the audio is generated for the text input. The audio can be generated using a universal model. The universal model is the same as or similar to UVM 306 and UVM 406 illustrated and described in more detail with reference to FIGS. 3 and 4 respectively. Methods and algorithms used by the universal model to produce the audio are illustrated and described in more detail with reference to FIGS. 4-7.

In step 1806, the system validates the request by authenticating the audio input by comparing the acoustic properties of an audio input from the user with the linguistic features of the reference text. For example, the system asks the reader to read a consent statement as discussed in further detail in FIGS. 15 and 16. In response to determining that the audio input is authentic, the system authenticates the request. In some embodiments, authenticating the request includes confirming a user's consent to proceed with generating the audio, such as by reading the consent statement. In some embodiments, authenticating the request includes determining that the audio input is received within a predefined period of time after providing the reference text. Comparing the audio input with the reference text includes evaluating the degree of similarity or correspondence between the acoustic properties of the audio input and the linguistic features of the reference text. If the observed similarity meets predefined criteria or thresholds, the system considers the audio input to be authentic.

The system can extract relevant features from both the audio input and the reference text. For acoustic properties, features such as pitch, formants, energy distribution, and spectral characteristics may be extracted using techniques described in further detail in FIGS. 4-7. Linguistic features may include word frequencies, syntactic structures, semantic meaning, and lexical characteristics, and can be extracted using techniques described in further detail in FIGS. 4-7.

In some embodiments, the audio and linguistic features are transformed into numerical vectors that capture the semantic meaning and relationships between words or phrases in the audio and text. Each feature is represented by a vector in a high-dimensional space, where similar words have similar vector representations. For example, Mel-frequency cepstral coefficients (MFCCs), which represent the spectral characteristics of the audio signal over time, can be represented as a sequence of feature vectors, one for each time frame. Similarly, spectrograms, which provide a visual representation of the frequency content of the audio signal over time, can be flattened into a one-dimensional vector. For text inputs, each word and/or phrase in the vocabulary is assigned a unique vector, where the values in the vector capture semantic relationships between words and/or phrases. The vectors are learned from large corpora of text data using techniques like Word2Vec, GloVe (Global Vectors for Word Representation), or fastText. During training, a model learns to predict the context of a word based on the surrounding words, resulting in embeddings that encode semantic similarities between words. For example, similar words like “king” and “queen” may have vectors that are close together in the embedding space, indicating semantic similarity.

Once the features are extracted, the system can calculate a similarity metric or distance measure between the two sets of features. For example, the system can calculate pairwise distances between vectors or measure similarity scores based on vector representations. By considering the distances or similarities between vectors, the system infers the spatial relationships and proximities between features within the sequence. The ML model can compute the distance between every pair of vectors in the dataset. Various distance metrics can be used, such as Euclidean distance, Manhattan distance, or cosine similarity. Euclidean distance measures the straight-line distance between two points in the vector space, while Manhattan distance calculates the distance along the axes. Cosine similarity measures the cosine of the angle between two vectors, indicating the similarity in the vectors' directions. Based on predefined criteria or thresholds, the system determines whether the observed similarity between the audio input and the reference text is sufficient to consider the audio input authentic. A threshold can contain cutoff values for similarity scores or distance measures, beyond which the audio input is deemed authentic.

In step 1808, if the request is not authenticated, the system keeps the overdubbing operation in a pending state. The system does not proceed with presenting or generating the audio until the request is authenticated. The pending state is a temporary holding status for the audio, allowing the system to defer further processing until the authenticity of the request can be confirmed. During this time, the system may prompt the user to provide additional information or consent to proceed with the generation process. In step 1810, if the request is authenticated, the system generates the audio.

In some embodiments, generating the audio in response to authenticating the request includes causing a speech synthesis model to create the audio based on the text input. The speech synthesis model determines alignment information that aligns the acoustic properties of the audio input with the linguistic features of the text input. The audio emulates the acoustic properties of the audio input in accordance with the linguistic features of the text input. The speech synthesis model is the same as or similar to UVM 306 and UVM 406 illustrated and described in more detail with reference to FIGS. 3 and 4 respectively. Methods and algorithms used by the universal model to produce synthesized speech outputs are illustrated and described in more detail with reference to FIGS. 4-7.

In some embodiments, the system assigns a priority level to the request based on user activity. Priority levels can be determined using a predefined scale or ranking system, where users with the highest activity receive the lowest priority, and vice versa. The prioritization approach ensures that users who have been less active or have submitted fewer requests are given precedence in the audio generation queue. The system then generates the audio based on the priority level of the request.

In some embodiments, the system provides a static set of consent statements. Each consent statement contains a randomized set of words, and the system assigns a consent statement within the static set of consent statements as the reference text. The system can dynamically determine a consent statement by directing an AI model to generate a plurality of discrete linguistic elements. The system randomly selects a subset of linguistic elements from the plurality of discrete linguistic elements and combines the subset of linguistic elements randomly to form a sentence or phrase, where the sentence or phrase includes a static segment containing necessary phonemes. The system assigns the consent statement as the reference text.

### AI System

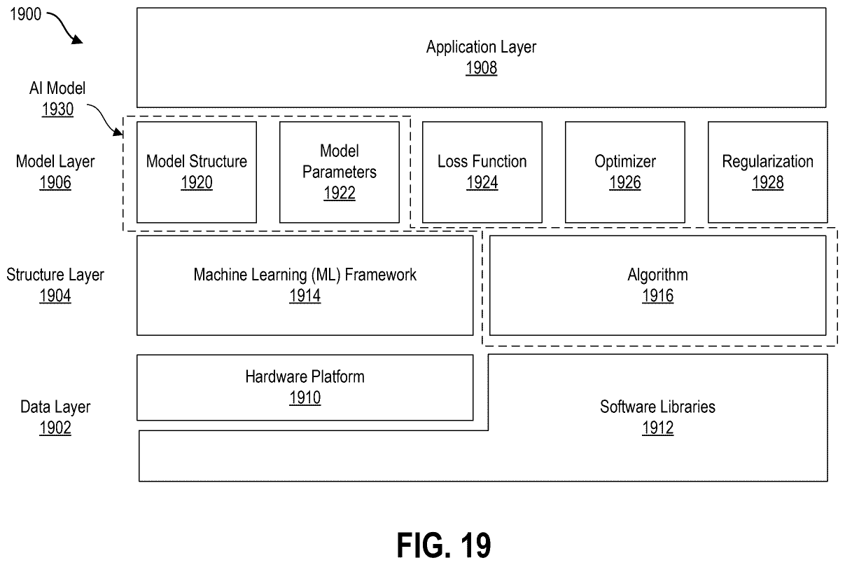

FIG. 19 is a high-level block diagram illustrating an example AI system, in accordance with one or more embodiments. The AI system 1900 is implemented using components of the example computer system 2000 illustrated and described in more detail with reference to FIG. 20. Likewise, embodiments of the AI system 1900 include different and/or additional components or be connected in different ways.

In some embodiments, as shown in FIG. 19, the AI system 1900 includes a set of layers, which conceptually organize elements within an example network topology for the AI system's architecture to implement a particular AI model 1930. Generally, an AI model 1930 is a computer-executable program implemented by the AI system 1900 that analyses data to make predictions. Information passes through each layer of the AI system 1900 to generate outputs for the AI model 1930. The layers include a data layer 1902, a structure layer 1904, a model layer 1906, and an application layer 1908. The algorithm 1916 of the structure layer 1904 and the model structure 1920 and model parameters 1922 of the model layer 1906 together form the example AI model 1930. The optimizer 1926, loss function engine 1924, and regularization engine 1928 work to refine and optimize the AI model 1930, and the data layer 1902 provides resources and support for the application of the AI model 1930 by the application layer 1908.

The data layer 1902 acts as the foundation of the AI system 1900 by preparing data for the AI model 1930. As shown, in some embodiments, the data layer 1902 includes two sub-layers: a hardware platform 1910 and one or more software libraries 1912. The hardware platform 1910 is designed to perform operations for the AI model 1930 and includes computing resources for storage, memory, logic, and networking, such as the resources described in relation to FIGS. 1-20. The hardware platform 1910 processes amounts of data using one or more servers. The servers can perform backend operations such as matrix calculations, parallel calculations, machine learning (ML) training, and the like. Examples of servers used by the hardware platform 1910 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 1910 includes Infrastructure as a Service (laaS) resources, which are computing resources, (e.g., servers, memory, etc.) offered by a cloud services provider. In some embodiments, the hardware platform 1910 includes computer memory for storing data about the AI model 1930, application of the AI model 1930, and training data for the AI model 1930. In some embodiments, the computer memory is a form of random-access memory (RAM), such as dynamic RAM, static RAM, and non-volatile RAM.

In some embodiments, the software libraries 1912 are thought of as suites of data and programming code, including executables, used to control the computing resources of the hardware platform 1910. In some embodiments, the programming code includes low-level primitives (e.g., fundamental language elements) that form the foundation of one or more low-level programming languages, such that servers of the hardware platform 1910 can use the low-level primitives to carry out specific operations. The low-level programming languages do not require much, if any, abstraction from a computing resource's instruction set architecture, allowing them to run quickly with a small memory footprint. Examples of software libraries 1912 that can be included in the AI system 1900 include Intel Math Kernel Library, Nvidia cuDNN, Eigen, and Open BLAS.

In some embodiments, the structure layer 1904 includes an ML framework 1914 and an algorithm 1916. The ML framework 1914 can be thought of as an interface, library, or tool that allows users to build and deploy the AI model 1980. In some embodiments, the ML framework 1914 includes an open-source library, an application programming interface (API), a gradient-boosting library, an ensemble method, and/or a deep learning toolkit that works with the layers of the AI system facilitate development of the AI model 1930. For example, the ML framework 1914 distributes processes for the application or training of the AI model 1930 across multiple resources in the hardware platform 1910. In some embodiments, the ML framework 1914 also includes a set of pre-built components that have the functionality to implement and train the AI model 1930 and allow users to use pre-built functions and classes to construct and train the AI model 1930. Thus, the ML framework 1914 can be used to facilitate data engineering, development, hyperparameter tuning, testing, and training for the AI model 1930. Examples of ML frameworks 1914 that can be used in the AI system 1900 include TensorFlow, PyTorch, Scikit-Learn, Keras, Caffe, LightGBM, Random Forest, and Amazon Web Services.

In some embodiments, the algorithm 1916 is an organized set of computer-executable operations used to generate output data from a set of input data and can be described using pseudocode. In some embodiments, the algorithm 1916 includes complex code that allows the computing resources to learn from new input data and create new/modified outputs based on what was learned. In some embodiments, the algorithm 1916 builds the AI model 1930 through being trained while running computing resources of the hardware platform 1910. The training allows the algorithm 1916 to make predictions or decisions without being explicitly programmed to do so. Once trained, the algorithm 1916 runs at the computing resources as part of the AI model 1930 to make predictions or decisions, improve computing resource performance, or perform tasks. The algorithm 1916 is trained using supervised learning, unsupervised learning, semi-supervised learning, and/or reinforcement learning. The application layer 1908 describes how the AI system 1900 is used to solve problems or perform tasks.

As an example, to train an AI model 1930 that is intended to model human language (also referred to as a language model), the data layer 1902 is a collection of text documents, referred to as a text corpus (or simply referred to as a corpus). The corpus represents a language domain (e.g., a single language), a subject domain (e.g., scientific papers), and/or encompasses another domain or domains, be they larger or smaller than a single language or subject domain. For example, a relatively large, multilingual, and non-subject-specific corpus is created by extracting text from online web pages and/or publicly available social media posts. In some embodiments, data layer 1902 is annotated with ground truth labels (e.g., each data entry in the training dataset is paired with a label), or unlabeled.

Training an AI model 1930 generally involves inputting into an AI model 1930 (e.g., an untrained ML model) data layer 1902 to be processed by the AI model 1930, processing the data layer 1902 using the AI model 1930, collecting the output generated by the AI model 1930 (e.g., based on the inputted training data), and comparing the output to a desired set of target values. If the data layer 1902 is labeled, the desired target values, in some embodiments, are, e.g., the ground truth labels of the data layer 1902. If the data layer 1902 is unlabeled, the desired target value is, in some embodiments, a reconstructed (or otherwise processed) version of the corresponding AI model 1930 input (e.g., in the case of an autoencoder), or is a measure of some target observable effect on the environment (e.g., in the case of a reinforcement learning agent). The parameters of the AI model 1930 are updated based on a difference between the generated output value and the desired target value. For example, if the value outputted by the AI model 1930 is excessively high, the parameters are adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the AI model 1930 typically is to minimize a loss function or maximize a reward function.

In some embodiments, the data layer 1902 is a subset of a larger data set. For example, a data set is split into three mutually exclusive subsets: a training set, a validation (or cross-validation) set, and a testing set. The three subsets of data, in some embodiments, are used sequentially during AI model 1930 training. For example, the training set is first used to train one or more ML models, each AI model 1930, e.g., having a particular architecture, having a particular training procedure, being describable by a set of model hyperparameters, and/or otherwise being varied from the other of the one or more ML models. The validation (or cross-validation) set, in some embodiments, is then used as input data into the trained ML models to, e.g., measure the performance of the trained ML models and/or compare performance between them. In some embodiments, where hyperparameters are used, a new set of hyperparameters is determined based on the measured performance of one or more of the trained ML models, and the first step of training (i.e., with the training set) begins again on a different ML model described by the new set of determined hyperparameters. These steps are repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) begins in some embodiments. The output generated from the testing set, in some embodiments, is compared with the corresponding desired target values to give a final assessment of the trained ML model's accuracy. Other segmentations of the larger data set and/or schemes for using the segments for training one or more ML models are possible.

Backpropagation is an algorithm for training an AI model 1930. Backpropagation is used to adjust (also referred to as update) the value of the parameters in the AI model 1930, with the goal of optimizing the objective function. For example, a defined loss function is calculated by forward propagation of an input to obtain an output of the AI model 1930 and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. In some embodiments, other techniques for learning the parameters of the AI model 1930 are used. The process of updating (or learning) the parameters over many iterations is referred to as training. In some embodiments, training is carried out iteratively until a convergence condition is met (e.g., a predefined maximum number of iterations has been performed, or the value outputted by the AI model 1930 is sufficiently converged with the desired target value), after which the AI model 1930 is considered to be sufficiently trained. The values of the learned parameters are then fixed and the AI model 1930 is then deployed to generate output in real-world applications (also referred to as “inference”).

In some examples, a trained ML model is fine-tuned, meaning that the values of the learned parameters are adjusted slightly in order for the ML model to better model a specific task. Fine-tuning of an AI model 1930 typically involves further training the ML model on a number of data samples (which may be smaller in number/cardinality than those used to train the model initially) that closely target the specific task. For example, an AI model 1930 for generating natural language that has been trained generically on publicly available text corpora is, e.g., fine-tuned by further training using specific training samples. In some embodiments, the specific training samples are used to generate language in a certain style or a certain format. For example, the AI model 1930 is trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

In some embodiments, the language model uses a neural network (typically a DNN) to perform NLP tasks. A language model is trained to model how words relate to each other in a textual sequence, based on probabilities. In some embodiments, the language model contains hundreds of thousands of learned parameters, or in the case of a large language model (LLM) contains millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

Although a general transformer architecture for a language model and the model's theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that is considered to be an encoder-only language model. A decoder-only language model accepts embeddings as input and uses auto-regression to generate an output text sequence. Transformer-XL and GPT-type models are language models that are considered to be decoder-only language models.

Because GPT-type language models tend to have a large number of parameters, these language models are considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that GPT-3 can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some embodiments, such as, for example, potentially in the case of a cloud-based language model, a remote language model is hosted by a computer system that includes a plurality of cooperating (e.g., cooperating via a network) computer systems that are in, for example, a distributed arrangement. Notably, a remote language model employs a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real-time or near real-time) can require the use of a plurality of processors/cooperating computing devices as discussed above.

In some embodiments, inputs to an LLM are referred to as a prompt (e.g., command set or instruction set), which is a natural language input that includes instructions to the LLM to generate a desired output. In some embodiments, a computer system generates a prompt that is provided as input to the LLM via the LLM's API. As described above, the prompt is processed or pre-processed into a token sequence prior to being provided as input to the LLM via the LLM's API. A prompt includes one or more examples of the desired output, which provides the LLM with additional information to enable the LLM to generate output according to the desired output. Additionally or alternatively, the examples included in a prompt provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples is referred to as a zero-shot prompt.

In some embodiments, the llama2 is used as a large language model, which is a large language model based on an encoder-decoder architecture, and can simultaneously perform text generation and text understanding. The llama2 selects or trains proper pre-training corpus, pre-training targets and pre-training parameters according to different tasks and fields, and adjusts a large language model on the basis so as to improve the performance of the large language model under a specific scene.

In some embodiments, the Falcon40B is used as a large language model, which is a causal decoder-only model. During training, the model predicts the subsequent tokens with a causal language modeling task. The model applies rotational positional embeddings in the model's transformer model and encodes the absolution positional information of the tokens into a rotation matrix.

In some embodiments, the Claude is used as a large language model, which is an autoregressive model trained on a large text corpus unsupervised.

### Computing Platform

FIG. 20 is a block diagram illustrating an example computer system 2000, in accordance with one or more embodiments. In some embodiments, components of the example computer system 2000 are used to implement the software platforms described herein. At least some operations described herein can be implemented on the computer system 2000.

In some embodiments, the computer system 2000 includes one or more central processing units (“processors”) 2002, main memory 2006, non-volatile memory 2010, network adapters 2012 (e.g., network interface), video displays 2018, input/output devices 2020, control devices 2022 (e.g., keyboard and pointing devices), drive units 2024 including a storage medium 2026, and a signal generation device 2020 that are communicatively connected to a bus 2016. The bus 2016 is illustrated as an abstraction that represents one or more physical buses and/or point-to-point connections that are connected by appropriate bridges, adapters, or controllers. The bus 2016, therefore, includes a system bus, a peripheral component interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 2094 bus (also referred to as “Firewire”).

In some embodiments, the computer system 2000 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 2000.

While the main memory 2006, non-volatile memory 2010, and storage medium 2026 (also called a “machine-readable medium”) are shown to be a single medium, the terms “machine-readable medium” and “storage medium” should be taken to include a single medium or multiple media (e.g., a centralized/distributed database and/or associated caches and servers) that store one or more sets of instructions 2028. The term “machine-readable medium” and “storage medium” shall also be taken to include any medium that is capable of storing, encoding, or carrying a set of instructions for execution by the computer system 2000. In some embodiments, the non-volatile memory 2010 or the storage medium 2026 is a non-transitory, computer-readable storage medium storing computer instructions, which is executable by one or more “processors” 2002 to perform functions of the embodiments disclosed herein.

In general, the routines executed to implement the embodiments of the disclosure can be implemented as part of an operating system or a specific application, component, program, object, module, or sequence of instructions (collectively referred to as “computer programs”). The computer programs typically include one or more instructions (e.g., instructions 2004, 2008, 2028) set at various times in various memory and storage devices in a computer device. When read and executed by one or more processors 2002, the instruction(s) cause the computer system 2000 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually affect the distribution.

Further examples of machine-readable storage media, machine-readable media, or computer-readable media include recordable-type media such as volatile and non-volatile memory 2010 devices, floppy and other removable disks, hard disk drives, optical discs (e.g., compact disc read-only memory (CD-ROMS), digital versatile discs (DVDs)), and transmission-type media such as digital and analog communication links.

The network adapter 2012 enables the computer system 2000 to mediate data in a network 2014 with an entity that is external to the computer system 2000 through any communication protocol supported by the computer system 2000 and the external entity. The network adapter 2012 includes a network adapter card, a wireless network interface card, a router, an access point, a wireless router, a switch, a multilayer switch, a protocol converter, a gateway, a bridge, a bridge router, a hub, a digital media receiver, and/or a repeater.

In some embodiments, the network adapter 2012 includes a firewall that governs and/or manages permission to access proxy data in a computer network and tracks varying levels of trust between different machines and/or applications. The firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). In some embodiments, the firewall additionally manages and/or has access to an access control list that details permissions, including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc. A portion of the methods described herein can be performed using the example ML system 1900 illustrated and described in more detail with reference to FIG. 19.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the art to understand the claimed subject matter, the various embodiments, and the various modifications that are suited to the particular uses that are contemplated.

Although the Detailed Description describes various embodiments, the technology can be practiced in many ways no matter how detailed the Detailed Description appears. Embodiments may vary considerably in their embodiment details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

What is claimed is:

1. A computer-implemented method for synthesizing speech for a speaker, the method comprising:
acquiring a training dataset that includes (i) a plurality of audio samples and (ii) a plurality of textual phrases,
wherein each of the plurality of textual phrases is representative of words spoken within a corresponding one of the plurality of audio samples, and
wherein the plurality of audio samples are associated with a plurality of speakers, each of whom is associated with at least one of the plurality of audio samples;
providing the training dataset, as input, to a neural network that learns alignment information by aligning, for each of the plurality of audio samples, at least one acoustic property of that audio sample with at least one linguistic feature of the corresponding one of the plurality of textual phrases;
receiving input that is indicative of a request to synthesize speech for the speaker,
wherein the input includes (i) a reference audio sample that includes one or more words uttered by the speaker and (ii) a reference textual phrase that includes one or more words to be synthesized; and
providing (i) the reference audio sample and (ii) the reference textual phrase to the neural network that produces, as output, synthesized audio of the reference textual phrase as if spoken by the speaker.

2. The computer-implemented method of claim 1, wherein the neural network is a universal variable model that includes one or more of:
a duration predictor model,
an audio shape transformer model,
an alignment model,
a text-to-coarse audio model, or
a coarse-to-fine audio model.

3. The computer-implemented method of claim 1,
wherein the neural network is trained by masking random segments of input data, and
wherein the neural network is configured to generate an estimation of the masked random segments.

4. The computer-implemented method of claim 1, further comprising:
generating a magnitude spectrogram from the reference audio sample; and
using the magnitude spectrogram as input to the neural network to generate a set of voice characteristics of a speaker corresponding to the reference audio sample that includes one or more of: pitch, intonation, or timbre.

5. The computer-implemented method of claim 1, further comprising:
determining a frequency count for each word within the reference textual phrase;
based on the frequency count for each word within the reference textual phrase, generating a list of candidate segments to be removed from the reference textual phrase.

6. The computer-implemented method of claim 1, further comprising:
generating multiple versions of the synthesized audio, wherein the multiple versions are associated with different prosodic parameters that include variations in one or more of: pitch contour, speech rate, or vocal intensity;
storing the multiple versions in a database;
responsive to received user input from a computing device that indicates a particular version of the multiple versions, retrieving the particular version from the database; and
presenting the particular version on the computing device.

7. A non-transitory medium with instructions stored thereon that, when executed by a processor of a computing device, cause the computing device to perform operations comprising:
providing a training dataset that includes a set of audio samples and associated text prompts,
wherein each of the associated text prompts is representative of a transcription of a corresponding one of the set of audio samples; and
training a model using the training dataset, wherein the model is configured to determine alignment information that aligns one or more acoustic properties of each audio sample with one or more linguistic features of the associated text prompts in the training dataset;
receiving an input that includes a reference audio sample and reference text,
wherein the reference audio sample and the reference text are not included in the training dataset, and
wherein the reference text is not representative of a transcription of the reference audio sample; and
using the alignment information and the input, generating, with the model, synthesized speech that emulates the acoustic properties of the reference audio sample in accordance with the linguistic features of the reference text.

8. The non-transitory medium of claim 7,
wherein training the model includes predicting a duration of each phoneme in the reference text,
wherein the predicted durations are used in generating the synthesized speech by:
determining a temporal alignment between the phonemes and the reference audio sample, and
adjusting the duration of each phoneme in the synthesized speech in accordance with the predicted durations to emulate the acoustic properties of the reference audio sample in accordance with the linguistic features of the reference text.

9. The non-transitory medium of claim 7, wherein the model is configured to:
extract spectral and temporal features from the reference audio sample, transform the spectral and temporal features into a compressed representation, discretize the compressed representation into acoustic tokens at a specified bitrate, map the acoustic tokens to the linguistic features of the reference text,
using the acoustic tokens and the linguistic features, modulate a waveform representative of the acoustic tokens and the linguistic features, and
generate the synthesized speech using the modulated waveform.

10. The non-transitory medium of claim 9, wherein the model is configured to:
compare phonetic transcriptions of the reference text and the acoustic tokens of the reference audio sample, and
generate an alignment matrix using the comparison,
wherein each element in the alignment matrix corresponds to an index of a voiced phoneme of the reference audio sample at a current timestep of the reference audio sample.

11. The non-transitory medium of claim 10, wherein the model is configured to:
parse through the reference text and the alignment matrix,
identify coarse acoustic tokens from the acoustic tokens, the coarse acoustic tokens representative of the reference text in accordance with the alignment matrix, and
adjust parameters of the synthesized speech based on the coarse acoustic tokens.

12. The non-transitory medium of claim 10, wherein the model is configured to:
generate refined acoustic tokens by iteratively adjusting the acoustic tokens to match the acoustic properties of the reference text,
wherein the refined acoustic tokens are used in generating the synthesized speech by modulating parameters of the synthesized speech based on the refined acoustic tokens.

13. The non-transitory medium of claim 7, wherein the model is stored in a cloud environment hosted by a cloud provider with scalable resources or a self-hosted environment hosted by a local server.

14. A non-transitory medium with instructions stored thereon that, when executed by a processor of a computing device, cause the computing device to perform operations comprising:
receiving, through an interface, text input and an assigned speaker;
applying a model to generate synthesized speech using an audio file indicative of a voice of the assigned speaker and the text input by:
supplying an input associated with the text input and the audio file into the model,
responsive to supplying the input, receiving, from the model, the synthesized speech,
wherein the model is configured to determine alignment information that aligns acoustic properties of the audio file with linguistic features of the text input, and
wherein the synthesized speech is configured to emulate the voice of the assigned speaker in accordance with the linguistic features of the text input;
responsive to receiving the synthesized speech from the model, dynamically updating the interface based on the synthesized speech,
wherein the updated interface is indicative of a new audio file associated with the text input; and
presenting the new audio file through the updated interface.

15. The non-transitory medium of claim 14, further comprising:
providing a set of options related to parameters of the synthesized speech, including one or more of: pitch, speed, or emphasis;
receiving a selected option within the set of options to modify the parameters of the synthesized speech; and
modifying the parameters of the synthesized speech based on the selected option.

16. The non-transitory medium of claim 14, further comprising:
presenting a selection of available voices of the assigned speaker in the interface;
receiving a selected voice from the presented selection; and
assigning the selected voice to the assigned speaker.

17. The non-transitory medium of claim 14, further comprising displaying visual cues indicating one or more of: pauses, intonations, or emphasis in the interface alongside the synthesized speech.

18. The non-transitory medium of claim 14, further comprising:
generating the input of the model by converting the audio file into a frequency domain indicator,
wherein the frequency domain indicator indicates the audio file based on frequencies associated with the audio file,
wherein the input includes the frequency domain indicator associated with the audio file.

19. The non-transitory medium of claim 14, further comprising:
receiving an edited text input;
in response to receiving the edited text input, triggering regeneration of the synthesized speech based on the edited text input, wherein the regeneration includes updating the acoustic properties of the synthesized speech in accordance with the linguistic features of the edited text input.

20. The non-transitory medium of claim 14, further comprising:
displaying the text input and corresponding synthesized speech in the interface; and
dynamically updating the interface as the synthesized speech is generated.
